(19) United States
(12) Patent Application Publication
(10) Pub. No.: US 2017/0201359 A1
(43) Pub. Date: Jul. 13, 2017

(54) METHOD, APPARATUS, AND COMPUTER READABLE MEDIUM FOR TRANSMITTING PILOTS IN WIRELESS LOCAL AREA NETWORKS

(71) Applicant: Intel IP Corporation, Santa Clara, CA (US)

(72) Inventors: Qinghua Li, San Ramon, CA (US); Xiaogang Chen, Hillsboro, OR (US); Yuan Zhu, Beijing (CN); Xintian E. Lin, Palo Alto, CA (US); Honggang Li, Beijing (CN); Robert J. Stacey, Portland, OR (US)

(73) Assignee: Intel IP Corporation, Santa Clara, CA (US)

(21) Appl. No.: 15/315,218

(22) PCT Filed: Dec. 22, 2014
(86) PCT No.: PCT/US2014/071942

§ 371 Date: Nov. 30, 2016

Related U.S. Application Data
(60) Provisional application No. 62/026,277, filed on Jul. 18, 2014.

(51) Int. Cl. H04L 5/00; H04W 72/04

(52) U.S. Cl. CPC H04L 5/0048; H04W 72/0453; H04W 84/12

(57) ABSTRACT

Methods, apparatuses, and computer-readable media for a wireless communication device for transmitting pilots in a wireless local area network are disclosed. The method on a wireless communication device includes receiving one or more packets in a transmit opportunity (TXOP), wherein the one or more packets indicate a schedule for the wireless communications device to transmit. The method further includes transmitting a first pilot carrier in a lower subcarrier of a frequency allocation, and transmitting a second pilot carrier in a higher subcarrier of the frequency allocation. The first pilot and the second pilot may be transmitted simultaneously or in alternative time periods. The lower subcarrier may be the lower one-third of the frequency allocation, and the higher subcarrier may be the higher one-third of the frequency allocation. The wireless communication device may transmit and receive in accordance with OFDMA and 802.11.

### PRIORITY CLAIM

This application claims the benefit of priority to U.S. Provisional Patent Application Ser. No. 62/026,277, filed Jul. 18, 2014, which is incorporated herein by reference in its entirety.

### TECHNICAL FIELD

Embodiments pertain to wireless networks. Some embodiments relate to pilot design in wireless local area networks (WLANs) operating in accordance with one of the Institute for Electrical and Electronic Engineers (IEEE) 802.11 standards, such as the IEEE 802.11ac standard and/or the IEEE 802.11ax. Some embodiments relate to high-efficiency (HE) wireless or high-efficiency WLAN (HEW) communications.

### BACKGROUND

Often wireless communication devices use pilots to assist in communicating. For example, the initial residual carrier frequency (CFO) is often estimated by a long training field (LTF), and after the LTF in 802.11 pilots may be used to determine the residual CFO and the sampling clock offset (SCO). However, pilots often use part of the bandwidth to transmit, which may make the communication less efficient.

Thus, there are general needs for methods, apparatuses, and computer readable media for pilot designs.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates a method of transmitting pilots in a WLAN, according to some disclosed embodiments;

FIG. 3 illustrates a basic frequency allocation unit according to example embodiments;

FIG. 4 illustrates a method of transmitting pilots in a WLAN, according to example embodiments;

FIG. 5 illustrates a method of transmitting pilots in a WLAN, according to example embodiments;

FIGS. 6A and 6B illustrate pilot locations according to example embodiments;

FIG. 7 illustrates a method of transmitting pilots according to example embodiments;

FIG. 8 illustrates a method of transmitting pilots in a WLAN, according to some disclosed embodiments;

FIG. 9 illustrates a method of transmitting pilots in a WLAN, according to some disclosed embodiments;

FIG. 10A illustrates a method of transmitting pilots in a WLAN, according to some disclosed embodiments;

FIG. 10B illustrates a method of transmitting pilots in a WLAN, according to some disclosed embodiments;

FIG. 11 illustrates a method of transmitting pilots in a WLAN, according to some disclosed embodiments;

FIG. 12 illustrates a method of transmitting pilots in a WLAN, according to some disclosed embodiments;

FIG. 13 illustrates a method of transmitting pilots in a WLAN, according to some disclosed embodiments;

FIG. 14 illustrates a method of transmitting pilots in a WLAN, according to some disclosed embodiments;

FIG. 15 illustrates a method of transmitting pilots in a WLAN, according to some disclosed embodiments;

FIGS. 16 and 17 illustrate the effect of residual carrier frequency offset (CFO) and sampling clock offset (SCO) for pilot placements, according to example embodiments;

FIG. 18 illustrates a pilot design where two pilots are transmitted on either end of the frequency allocations;

FIG. 19 illustrates a pilot design where the pilots are near the edge of the frequency allocation;

FIG. 20 illustrates a pilot design where some pilots are near the edge of the frequency allocation and a pilot are near the middle of the upper portion of the frequency allocation;

FIG. 21 illustrates pilot design for reduced pilots, according to some disclosed embodiments;

FIG. 22 illustrates the packet error rates from a simulation with different number and placement of pilots; and

FIG. 23 illustrates a HEW device in accordance with example embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

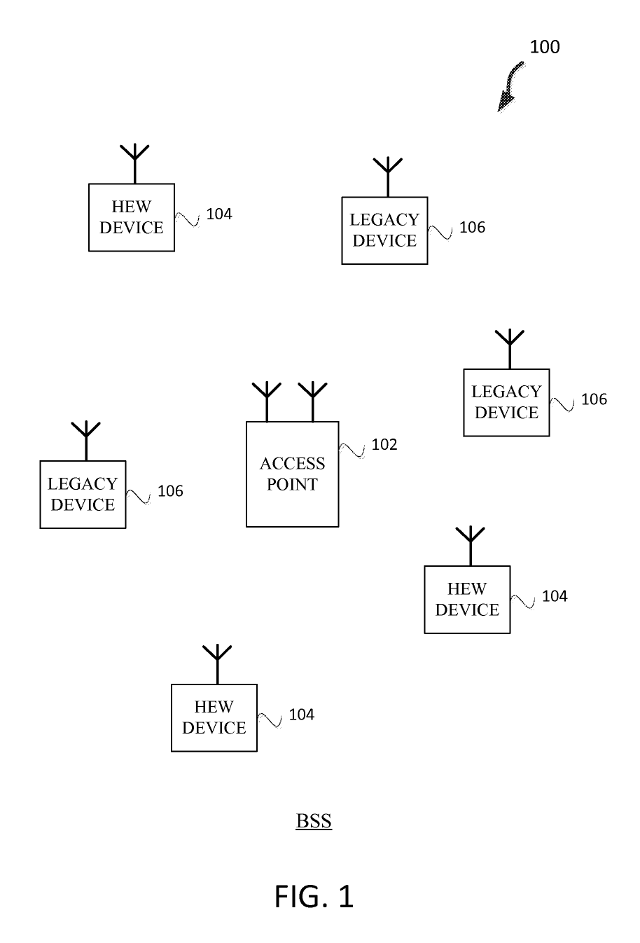

FIG. 1 illustrates a wireless network in accordance with some embodiments. The wireless network may comprise a basic service set (BSS) 100 that may include an access point (AP) 102, a plurality of high-efficiency wireless (HEW) devices 104 and a plurality of legacy devices 106.

The AP 102 may be an access point (AP) using the Institute of Electrical and Electronics Engineers (IEEE) 802.11 to transmit and receive. The AP 102 may be a base station. The AP 102 may use other communications protocols as well as the 802.11 protocol. For example, the AP 102 may use 802.16. The 802.11 protocol may be 802.11ax. The 802.11 protocol may include using orthogonal frequency-division multiple access (OFDMA), time division multiple access (TDMA), and/or code division multiple access (CDMA). The 802.11 may include using multi-user (MU) multiple-input and multiple-output (MIMO)(MU-MIMO). The HEW devices 104 may operate in accordance with 802.11ax or another standard of 802.11. The legacy devices 106 may operate in accordance in accordance with one or more of 802.11 a/g/ag/n/ac, or another legacy wireless communication standard.

The HEW devices 104 may be wireless transmit and receive devices such as a cellular telephone, handheld wireless device, wireless glasses, wireless watch, wireless personal device, tablet, or another device that may be transmitting and receiving using the 802.11 protocol such as 802.11ax or another wireless protocol.

The BSS 100 may operate on a primary channel and one or more secondary channels or sub-channels. The BSS 100 may include one or more APs 102. In accordance with embodiments, the AP 102 may communicate with one or more of the HEW devices 104 on one or more of the secondary channels or sub-channels or the primary channel. In example embodiments, the AP 102 communicates with the legacy devices 106 on the primary channel. In example embodiments, the AP 102 may be configured to communicate concurrently with one or more of the HEW devices 104 on one or more of the secondary channels and a legacy device 106 utilizing only the primary channel and not utilizing any of the secondary channels.

The AP 102 may communicate with legacy devices 106 in accordance with legacy IEEE 802.11 communication techniques. In example embodiments, the AP 102 may also be configured to communicate with HEW devices 104 in accordance with legacy IEEE 802.11 communication techniques. Legacy IEEE 802.11 communication techniques may refer to any IEEE 802.11 communication technique prior to IEEE 802.11ax.

In some embodiments, HEW frames may be configurable to have the same bandwidth and the bandwidth may be one of 20 MHz, 40 MHz, or 80 MHz contiguous bandwidths or an 80+80 MHz (160 MHz) non-contiguous bandwidth. In some embodiments, a 320 MHz contiguous bandwidth may be used. In some embodiments, bandwidths of 1 MHz, 1.25 MHz, 2.5 MHz, 5 MHz and 10 MHz, or a combination thereof, may also be used. In these embodiments, an HEW frame may be configured for transmitting a number of spatial streams.

In other embodiments, the AP 102, HEW device 104, and/or legacy device 106 may implement different technologies such as CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Long Term Evolution (LTE), Enhanced Data rates for GSM Evolution (EDGE), GSM EDGE (GERAN), BlueTooth®, IEEE 802.16 (i.e., Worldwide Interoperability for Microwave Access (WiMAX)).

In an OFDMA system such as 802.11ax, an associated HEW device 104 may operate on a sub-channel of the BSS 100 (that can operate, for example, at 80 MHz) where the sub-channel may be a portion of the 80 MHz (e.g., 1.25 MHz, 2.5 MHz, etc.).

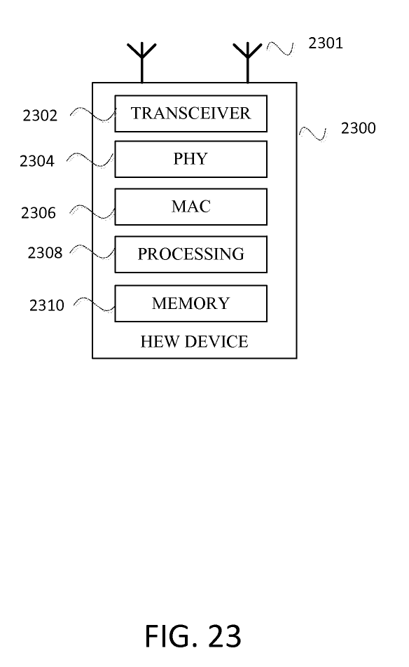

In example embodiments, an AP 102, HEW devices 104, and legacy devices 106 use carrier sense multiple access/collision avoidance (CSMA/CA). In some embodiments, the media access control (MAC) layer 2306 (see FIG. 23) controls access to the wireless media.

In example embodiments, an AP 102, HEW devices 104, and legacy devices 106, perform carrier sensing and can detect whether or not the channel is free. For example, an AP 102, HEW device 104, or legacy device 106 may use clear channel assessment (CCA) which may include a determination whether or not the channel is clear based on a Decibel-milliwatts (dBm) level of reception. In example embodiments, the physical layer (PHY) 2304 is configured to determine a CCA for an AP 102, HEW devices 104, and legacy devices 106.

After determining that the channel is free, an AP 102, HEW device 104, and legacy devices 106 defer their attempt to access the channel a back-off time to avoid collisions. In example embodiments, an AP 102, HEW device 104, and legacy devices 106 determine the back-off time by first waiting a specific amount of time and then adding a random back-off time, which, in some embodiments, is chosen uniformly between 0 and a current contention window (CS) size.

In example embodiments, an AP 102, HEW devices 104, and legacy devices 106 access the channel in different ways. For example, in accordance with some IEEE 802.11ax (High-Efficiency Wi-Fi (HEW)) embodiments, an AP 102 may operate as a master station which may be arranged to contend for a wireless medium (e.g., during a contention period) to receive exclusive control of the medium for an HEW control period (i.e., a transmission opportunity (TXOP)). The AP 102 may transmit an HEW master-sync transmission at the beginning of the HEW control period. During the HEW control period, HEW devices 104 may communicate with the AP 102 in accordance with a non-contention based multiple access technique. This is unlike conventional Wi-Fi communications in which legacy devices 106 and, optionally, HEW devices 104 communicate in accordance with a contention-based communication technique, rather than a non-contention multiple access technique. During the HEW control period, the AP 102 may communicate with HEW devices 104 using one or more HEW frames. During the HEW control period, legacy devices 106 refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In some embodiments, the multiple access technique may be a TDMA, CDMA or a frequency division multiple access (FDMA) technique. In some embodiments, the multiple access technique may be a space-division multiple access (SDMA) technique or uplink MU-MIMO (UL MU-MMIO).

The AP 102 may also communicate with legacy devices 106 in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In example embodiments, the AP 102 is configured to perform one or more of the functions and/or methods described herein such determining a method or design of pilot carriers for the HEW devices 104 to use and indicate to the HEW devices 104 to use the method or design. The AP 102 may be configured to determine the CFO and SCO using the reduced number of pilot subcarriers the HEW devices 104 transmit to the AP 102. The AP 102 may be configured to transmit a reduced number of pilot subcarriers to the HEW devices 104.

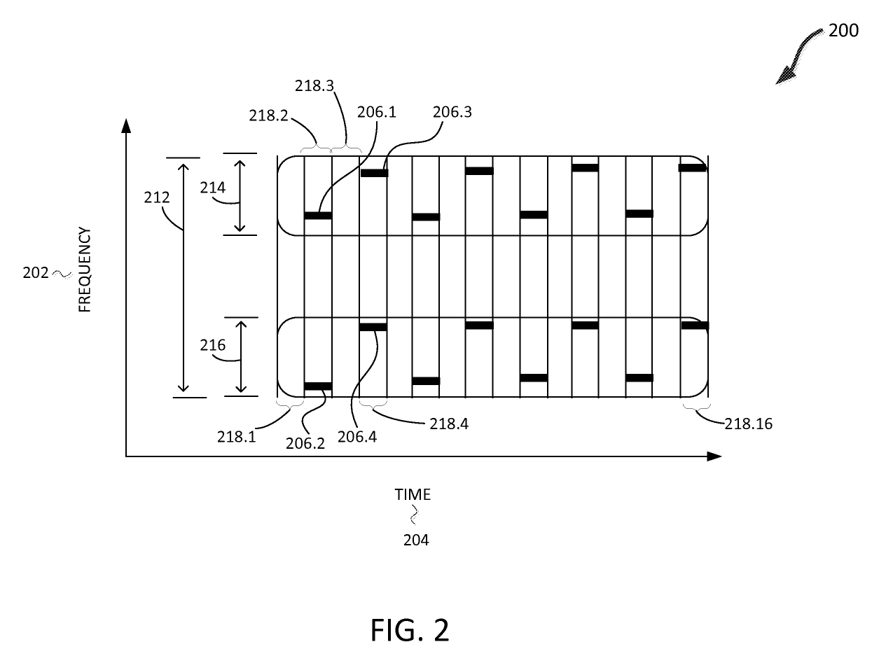

FIG. 2 illustrates a method 200 of transmitting pilots in a WLAN, according to some disclosed embodiments. Illustrated in FIG. 2 is time 204 along a horizontal axis and frequency 202 along a vertical axis. Also illustrated are an allocation bandwidth 212, an upper subcarrier range 214, a lower subcarrier range 216, pilots 206, and time periods 218.1 through 218.16. A HEW device 104 (FIG. 1) transmits in an allocation bandwidth 212 pilots 206 during time periods 218.1 through 218.16. The time periods 218 may be an OFDM or OFDMA symbol.

The allocation bandwidth 212 may be a bandwidth such as 1.25 MHz, 2.03125 MHz, 2.5 MHz, 5 MHz, 10 MHz, 20 MHz, 40 MHz, 80 MHz, 160 MHz, or multiples of one or more of the bandwidths such as multiples of 2.03125 MHz (which may have 24 data subcarriers and 2 pilot subcarriers), or another bandwidth. The upper subcarrier range 214 and the lower subcarrier range 216 may be a range of the allocation bandwidth 212. For example, the upper subcarrier range 214 may be the top one third of the allocation bandwidth 212. For example, if the allocation bandwidth 212 was 20 MHz, then the upper subcarrier range 214 may be 13.66 MHz through 20 MHz.

As another example, the allocation bandwidth 212 may be 20 MHz with 256 subcarriers. The upper subcarrier range 214 may be one through sixty subcarriers at the higher end of the frequency. In some embodiments, the upper subcarrier range 214 may not include a top portion of the frequency. For example, the upper subcarrier range 214 may not include the top one, two, or three subcarriers. Other ranges for the upper subcarrier range 214 are possible such as the top one tenth, the top one ninth, the top one eight, the top one seventh, the top one sixth, the top one fifth, the top one fourth, and the top half. As another example, the lower subcarrier range 216 may be one or more subcarriers of the bottom half of the allocation bandwidth 212.

Similarly, the lower subcarrier range 216 may be the bottom one third of the allocation bandwidth 212. For example, if the allocation bandwidth 212 was 20 MHz, then the bottom subcarrier range 216 may be 0 MHz through 6.66 MHz. As another example, the allocation bandwidth 212 may be 20 MHz with 256 subcarriers. The lower subcarrier range 216 may be one through sixty subcarriers at the lower end of the frequency. In some embodiments, the lower subcarrier range 216 may not include a lower portion of the frequency. For example, the lower subcarrier range 216 may not include the bottom one, two, or three subcarriers. Other ranges for the lower subcarrier range 216 are possible such as the bottom one tenth, the bottom one ninth, the bottom one eight, the bottom one seventh, the bottom one sixth, the bottom one fifth, the bottom one fourth, and the bottom half. As another example, the lower subcarrier range 216 may be one or more subcarriers of the bottom half of the allocation bandwidth 212. The time periods 218 may be time periods of transmitting a symbol.

The method 200 begins at 218.1 with the HEW device 104 transmitting at 218.1. The HEW device 104 may have received a frame that indicates how pilots 206 are to be transmitted. The HEW device 104 may determine how pilots 206 are to be transmitted based on a size of the allocation. For example, if the frequency allocation bandwidth 212 is 4.0625 MHz, which may be two times a frequency allocation of 2.03125, then the HEW device 104 may determine to transmit two pilots 206: one in the upper subcarrier range 214 and one in the lower subcarrier range 216.

The method 200 continues at 218.2 with the HEW device 104 transmitting a pilot 206.1 in the upper subcarrier range 214 and a pilot 206.2 in the lower subcarrier range 216. The pilots 206 are being transmitted to an AP 102 (FIG. 1). The HEW device 104 then does not transmit a pilot 206 during the next time period 218.3. The method 200 may continue at 218.4 with the HEW device 104 transmitting pilot 206.3 in an upper subcarrier range 214 and pilot 206.4 in a lower subcarrier range 216. The method 200 may continue with HEW device 104 alternating between transmitting two pilots 206 and not transmitting pilots 206.

In some embodiments, the HEW device 104 is configured to not transmit pilots 206 during some time periods 218. For example, the HEW device 104 may skip one or more time periods 218 before transmitting the next pilot 206. In some embodiments, the HEW device 104 is configured to transmit at most two pilots 206 during a time period 218.

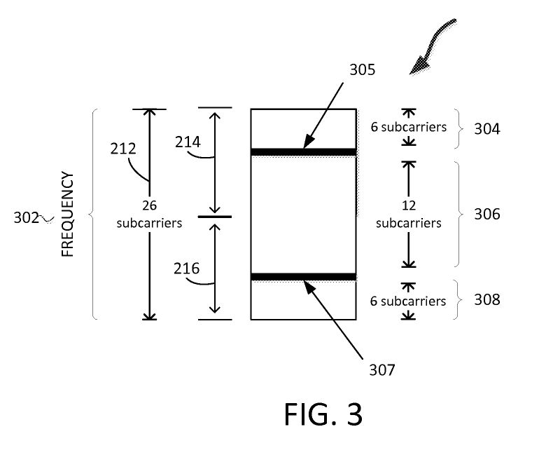

FIG. 3 illustrates a basic frequency allocation unit 300 according to example embodiments. A frequency 302 of 2.03125 MHz may be divided into 24 data subcarriers (e.g., 304, 306, 308) and two pilot subcarriers 305, 307 for a total of 26 subcarriers. The 26 subcarriers may be divided with 6 data subcarriers 304, a pilot subcarrier 305, 12 data subcarriers 306, a pilot subcarrier 307, and then 6 data subcarriers 308. The spacing between any two adjacent subcarriers may be 78.125 KHz. A HEW device 104 may be assigned one or more frequency allocation units 300 to use by the AP 102. The positions of the pilot subcarriers 305, 307 may be in different places. For example, the pilot subcarrier 305 may be one of the subcarriers of the upper subcarrier range 214, which may be the top 13 subcarriers. Moreover, the pilot subcarrier 307 may be one of the subcarriers of the lower subcarrier range 216, which may be the lower 13 subcarriers. The HEW device 104 may receive a frequency allocation bandwidth 212 that may be a multiple of the 2.03125 MHz.

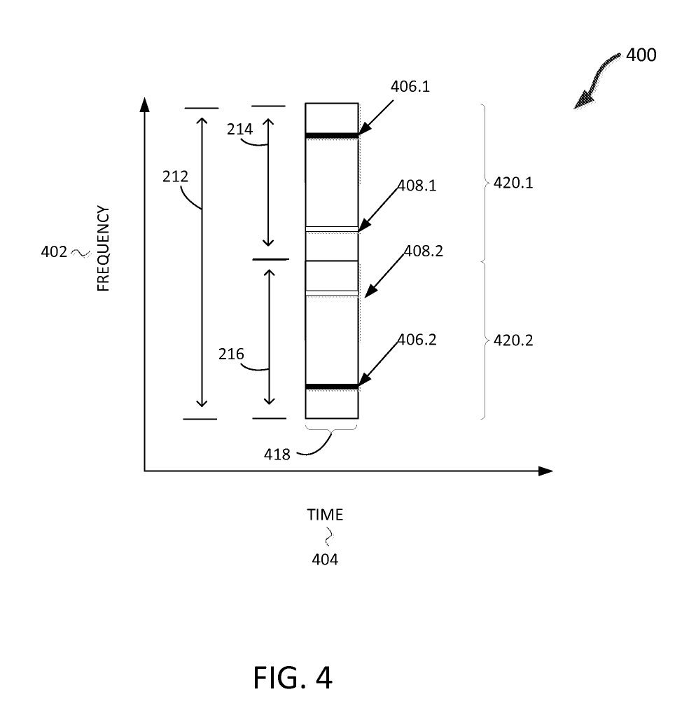

FIG. 4 illustrates a method 400 of transmitting pilots 206 in a WLAN, according to example embodiments. Illustrated in FIG. 4 are time 404 along a horizontal axis and frequency 402 along a vertical axis. Also illustrated are an allocation bandwidth 212, an upper subcarrier range 214, a lower subcarrier range 216, pilots 406, pilot locations 408, and time period 418. In example embodiments, the allocation bandwidth 212 may be composed of multiples of a basic allocation unit 420. For example, the basic allocation unit 420 may be the 26-subcarrier allocation illustrated in FIG. 3. In example embodiments, the pilot locations (e.g., 305, 307) of the basic frequency allocation unit 300 may be used to select the pilot locations 406 of an allocation bandwidth 212 that comprises multiples of the basic allocation unit 420. For example, 406.1 and 408.1 may correspond to pilot locations 305, 307, respectively.

A HEW device 104 (FIG. 1) transmits pilots 406 in an allocation bandwidth 212 during time period 418. The HEW device 104 may receive an indication of a method to use to transmit pilots 406 before the method begins. The allocation bandwidth 212 may be two times the basic allocation unit 420 illustrated in FIG. 3. In example embodiments, the allocation bandwidth 212 may be another multiple of the basic allocation unit 420. For example, the allocation bandwidth 212 may be 3 through 80 times the basic allocation unit 420. In example embodiments, the HEW device 104 does not use the pilot locations 408 when two consecutive basic allocation units 420 are allocated to the HEW device 104. The pilots 406 may be at a standard determined location based on the frequency allocation bandwidth 212 size. The pilots 406 may be on the top 420.1 and bottom 420.2 of the basic allocation units 420. For example, if there were 9 basic allocation units 420, in example embodiments, only the pilot locations 408 in the top and bottom basic allocation units 420 are used. In example embodiments, the pilot locations 408 in the top two or three and bottom two or three basic allocation units 420 may be used.

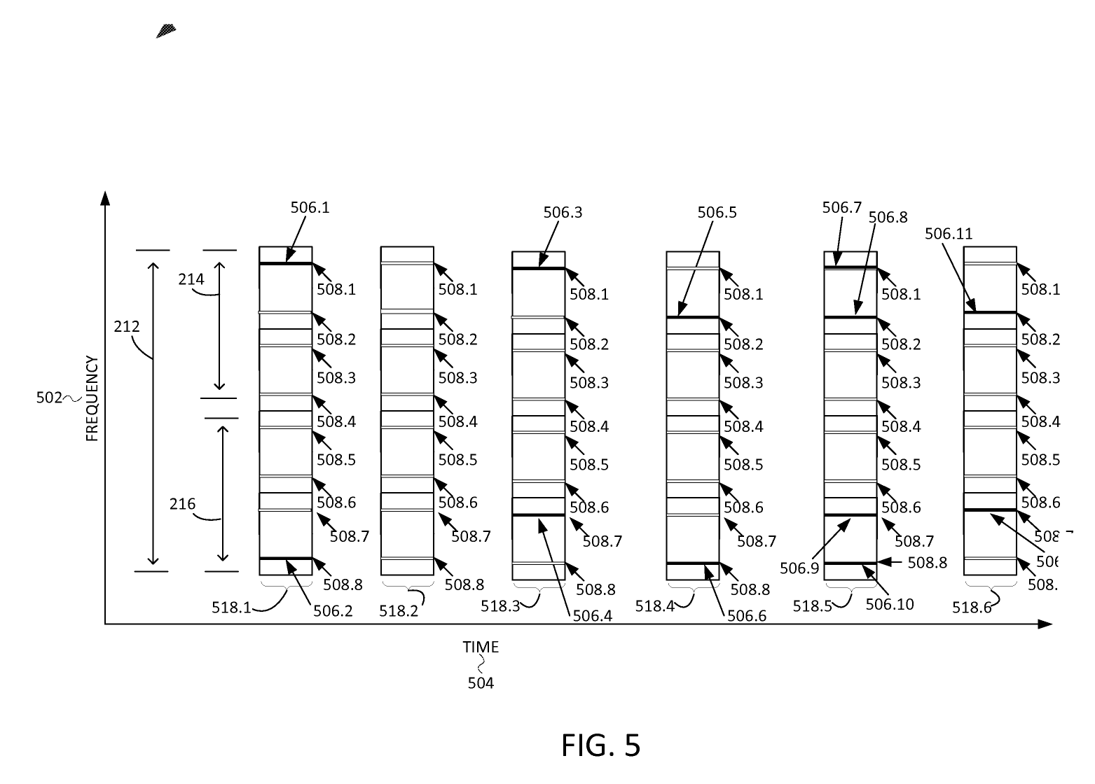

FIG. 5 illustrates a method 500 of transmitting pilots 506 in a WLAN, according to example embodiments. Illustrated in FIG. 5 are time 504 along a horizontal axis and frequency 502 along a vertical axis. Also illustrated are an allocation bandwidth 212, an upper subcarrier range 214, a lower subcarrier range 216, pilots 506, pilot locations 508, and time periods 518. The allocation bandwidth 212 may be four times the size of the frequency allocation bandwidth 212 illustrated in FIG. 3 with two pilot locations 508 per frequency allocation bandwidth 212. In example embodiments, fewer or more than four frequency allocation bandwidth 212 bandwidths illustrated in FIG. 3 may be used. For example, nine basic frequency allocation units 300 may be used for an allocation bandwidth 212 of nine times 2.03125 MHz (20 MHz.).

A HEW device 104 (FIG. 1) transmits pilots 506 in an allocation bandwidth 212 during time period 518.1. The HEW device 104 may receive an indication of a method to use to transmit pilots 506 before the method begins. For example, the HEW device 104 may transmit pilot 506.1 in pilot location 508.1 and pilot 506.2 in pilot location 508.8. The pilots 506 may be at a location determined by a standard. The pilots 506 location may be based on the frequency allocation bandwidth 212 size. The pilot locations 508 may be locations based on a standard.

The HEW device 104 may continue using the same pilot pattern as in time period 518.1. For example, the HEW device 104 may send the same pilot pattern as in time period 518.1 in time period 518.2. The HEW device 104 may send other pilot patterns. For example, the HEW device 104 may transmit a pilot pattern as illustrated in time period 518.2 where no pilots 506 are transmitted. The HEW device 104 may transmit a pilot pattern as illustrated in time period 518.3 where a pilot 506.3 is transmitted in pilot position 508.1, and a pilot 506.4 is transmitted in pilot position 508.7.

The HEW device 104 may transmit pilots 506 as illustrated in time period 518.4 where a pilot 506.5 is transmitted in pilot position 508.2, and a pilot 506.6 is transmitted in pilot position 508.8. The HEW device 104 may transmit pilots 506 as illustrated in time period 518.5 where a pilot 506.7 is transmitted in pilot position 508.1, a pilot 506.8 is transmitted in pilot position 508.2, a pilot 506.9 is transmitted in position 508.7, and a pilot 506.10 is transmitted in pilot position 508.8. The HEW device 104 may transmit pilots 506 as illustrated in time period 518.6 where a pilot 506.11 is transmitted in pilot position 508.2 and a pilot 506.12 is transmitted in pilot position 508.7.

The HEW device 104 may transmit the pilot patterns illustrated in time periods 518.1 through 506.6, and then transmit the same pilot pattern or a different pilot pattern. For example, the HEW 104 may transmit the pilot pattern illustrated in time period 518.4, and then transmit the pilot pattern illustrated in time period 518.3. The HEW device 104 may repeat this pattern by then transmitting the pilot pattern of time period 518.4 again. Other pilot patterns may also be used.

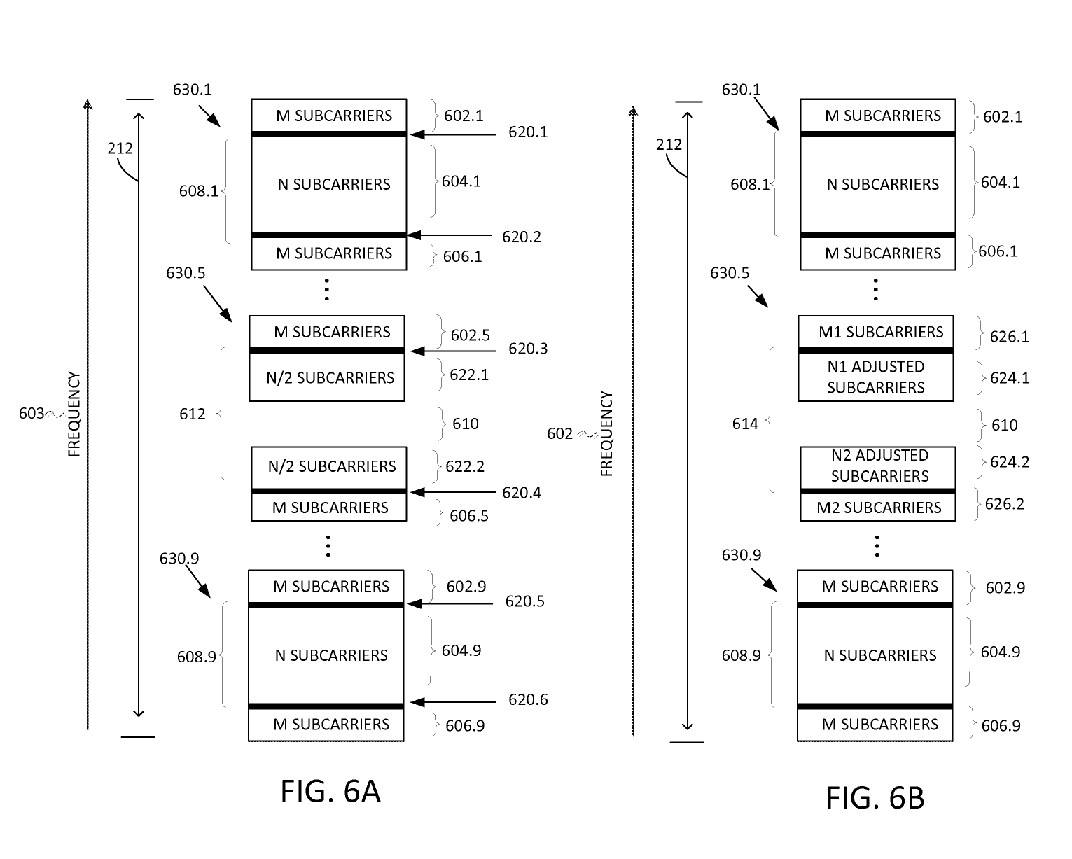

FIGS. 6A and 6B illustrate pilot locations according to example embodiments. Illustrated in FIGS. 6A and 6B are frequency 603 along a vertical axis, an allocation bandwidth 212, which may be one sub-channel, pilot locations 620, frequency allocation units 630, skipped subcarriers 610, N/2 subcarriers 622, N1 adjusted subcarriers 624.1, N2 adjusted subcarriers 624.2, M1 subcarriers 626.1, M2 subcarriers 626.2, M subcarriers 602.1-602.9, N subcarriers 604, and distance between pilot positions 608, 612, 614. Each of the frequency allocations 212 (FIGS. 6A and 6B), which may be one sub-channel and which may include nine frequency allocation units 630 that may be the basic frequency allocation units 300 as illustrated in FIG. 3. Each of the frequency allocation units 630 may be 2.03125 MHz and the total nine frequency allocation units 630 may be fitted into a 20 MHz subchanne1. Each frequency allocation unit 630 may include 26 subcarriers in total and 2 out the 26 subcarriers may be used for pilot locations 620.

M subcarriers 602.1-602.9 may be a number of subcarriers such as 0 to 13 subcarriers. For example, M may be 6 as illustrated in FIG. 3. N subcarriers 604 may be 26−2 (pilot locations 620)−(2*M subcarriers 606). For example, N may be 26−2 (pilots)−(2*6), which equals 12 as in FIG. 3. Skipped subcarriers 610 may be subcarriers that are not allocated (or skipped) because the subcarriers around the DC may be muted. For the 2.4 GHz frequency band, 3 subcarriers may be muted. For the 5 GHz frequency band, 5 subcarriers may be muted. In FIG. 6A, the values of M subcarrier 602.5 and N/2 subcarriers 622.2 are not adjusted due to the skipped subcarriers 610 so that the number of subcarriers between the pilot locations 620.3 and 620.4 is greater by the number of subcarriers in the skipped subcarriers 610. For example, for M subcarriers 602.1-602.9 being 6, then N subcarriers 604 is 26−2−(2*6)=12 subcarriers. And, pilot position 620.1, 620.3, 620.5 is 7 and pilot position 620.2, 620.4, 620.6 is then 20. If skipped subcarriers 610 is 3, then the distance between pilot positions 612 is then larger by 3, and for the example above, is 20-7+3=16 subcarriers whereas the distance between pilot positions for 608.1 and 608.9 is 20−7=13.

In FIG. 6B, the number of subcarriers in N1 adjusted subcarriers 624.1 and 624.2 may be adjusted so that the distance between pilot positions 614 is the same as the distance between pilot positions 608.1 and 608.9. For example, continuing the example above, N1 adjusted subcarriers 624.1 and N2 adjusted subcarriers 624.2 may respectively be 4 and 5 subcarriers instead of 6 subcarriers so that the distance between pilot positions 614 remains 13 subcarriers, (N1 adjusted subcarriers 624.1 and N2 adjusted subcarriers 624.2 are 4 and 5, respectively, and skipped subcarriers 610 is 3) the same as 608.1 and 608.9. The M1 subcarriers 626.1 and M2 subcarriers 626.2 would then be appropriately adjusted as well. For this example, values of M1 and M2 may be 8 and 7, respectively.

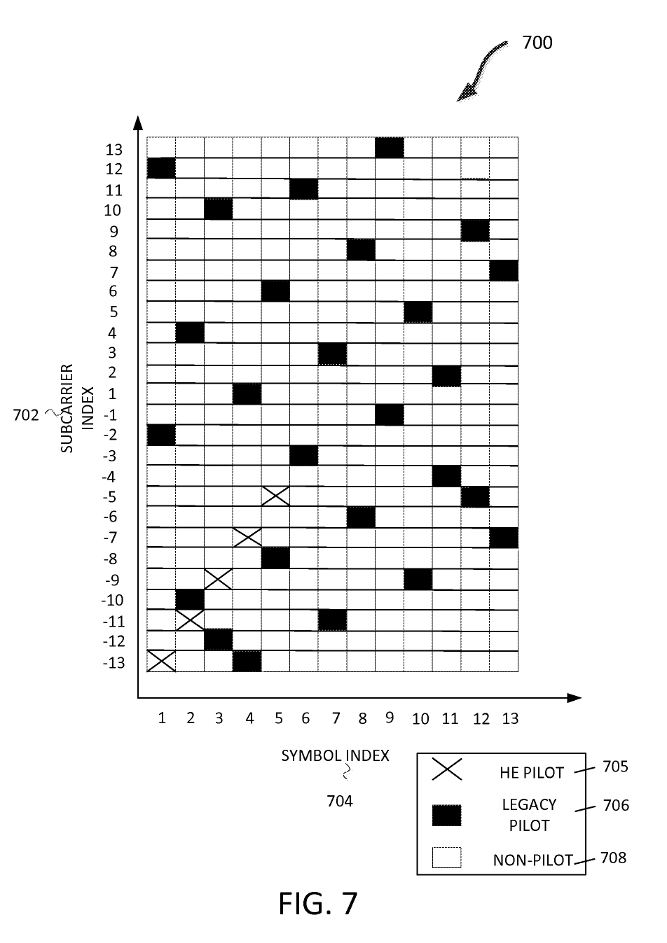

FIG. 7 illustrates a method 700 of transmitting pilots according to example embodiments. Illustrated in FIG. 7 is subcarrier index 702 along a vertical axis and symbol index 704 along a horizontal axis with filled in portions of symbols indicating a position where a legacy pilot 706 is transmitted, X's 705 where a high-efficiency pilot 705 is transmitted, and blank portions of symbols where no pilot is transmitted 708. A HEW device 104 may be configured to transmit a legacy pilot 706, which may be a running pilot, so that it visits either the even or odd subcarriers 702, or every fourth subcarrier 702 during a period, which may be number of symbols of duration such as 13 symbols. In example embodiments, the legacy pilots 706 may be running pilots for tracking channel variation over time.

The HEW devices 104 may be configured to transmit fewer than 13 symbols. Moreover, the HEW devices 104 may be configured to transmit symbols at four-times (4×) longer duration than legacy devices 106 so that the pilot may not need to visit every subcarrier 702 each period, and the HEW device 104 may be configured to transmit on subcarriers 702 that are four times denser than legacy devices 106. In example embodiments, the HEW device 104 may be configured to transmit a HE pilot 705 every L subcarriers 702 (e.g., with L=2, 3, 4, 5, or 6) in the first 5 symbols. In example embodiments, the pilot may scan the whole allocation within a period that is fewer than 13 symbols.

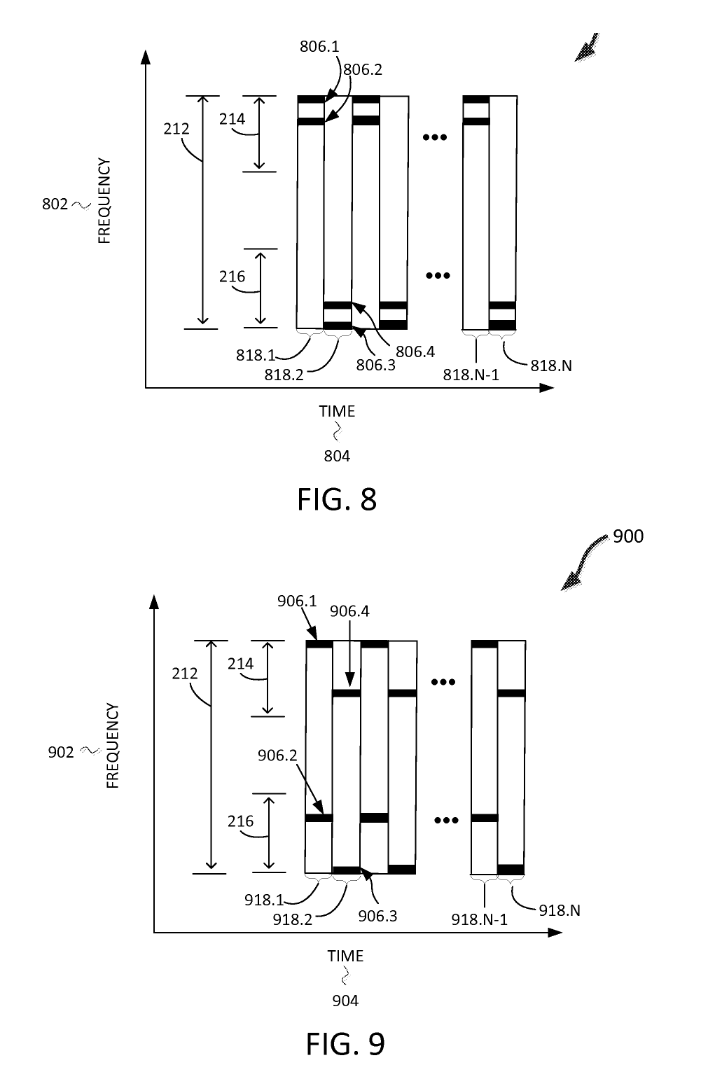

FIG. 8 illustrates a method 800 of transmitting pilots 806 in a WLAN, according to some disclosed embodiments. Illustrated in FIG. 8 are time 804 along a horizontal axis and frequency 802 along a vertical axis. Also illustrated are an allocation bandwidth 212, an upper subcarrier range 214, a lower subcarrier range 216, pilots 806, and time periods 818.1 through 818.N. An HEW device 104 (FIG. 1) transmits pilots 806 in an allocation bandwidth 212 during time periods 818.1 through 818.N. The HEW device 104 may receive an indication of a method to use to transmit pilots 806 before the method 800 begins.

The method 800 begins at 818.1 with the HEW device 104 transmitting pilot 806.1 and pilot 806.1 in the upper subcarrier range 214. The HEW device 104 may transmit pilot 806.1 and pilot 806.2 at or near the end of the upper subcarrier range 214. For example, the allocation bandwidth 212 may be 2.03125 MHz with 26 subcarriers indexed by 1, 2, . . . , 26. For example, the allocation bandwidth 212 may be as described in conjunction with FIG. 3 or 8 or a multiple of the allocation illustrated in FIG. 3 or 8. The HEW device 104 may transmit pilot 806.1 on subcarrier 26, 25, or 24, and pilot 806.2 on subcarrier 21, 20, or 19. Pilots 806.1 and pilot 806.2 may be transmitted with a gap between them. For example, there may be 4, 5, or 6 subcarriers 702 between pilot 806.1 and pilot 806.2 for a 26 subcarrier allocation bandwidth 212. As another example, the HEW device 104 may transmit pilot 806.1 on subcarrier 26 or 25 and pilot 306.2 on subcarrier 20 or 19.

The method 800 continues at 818.2 with the HEW device 104 transmitting pilot 806.3 and pilot 806.4 in the lower subcarrier range 216. The HEW device 104 may transmit pilot 806.3 and pilot 806.4 at or near the end of the lower subcarrier range 216. For example, the allocation bandwidth 212 may be 2.03125 MHz with 26 subcarriers. The HEW device 104 may transmit pilot 806.3 on subcarrier 3, 2, or 1, and pilot 806.4 on subcarrier 8, 7, or 6. Pilot 806.3 and pilot 806.4 may be transmitted with a gap between them. For example, there may be 4, 5 or 6 subcarriers between pilot 806.3 and pilot 306.4 for a 26 subcarrier allocation bandwidth 212.

The method 800 may continue with the HEW device 104 repeating the transmitting of two pilots 806 in the upper subcarrier range 214 and then two pilots 806 in the lower subcarrier range 216.

In some embodiments, the HEW device 104 is configured to not transmit pilots 806 during some time periods 806. For example, the HEW device 104 may skip one or more time periods 818 before transmitting the next pilots 806.3, 806.4. In some embodiments, the HEW device 104 may transmit one or more of the pilots 806 at a higher power than the HEW device 104 transmits data in some of the other subcarriers of the frequency allocation bandwidth 212.

FIG. 9 illustrates a method 900 of transmitting pilots 906 in a WLAN, according to some disclosed embodiments. Illustrated in FIG. 9 is time 904 along a horizontal axis and frequency 902 along a vertical axis. Also illustrated are an allocation bandwidth 212, an upper subcarrier range 214, a lower subcarrier range 216, pilots 906, and time periods 918.1 through 918.N. A HEW device 104 (FIG. 1) transmits pilots 906 in an allocation bandwidth 212 during time periods 918.1 through 918.N. The HEW device 104 may receive an indication of a method 900 to use to transmit pilots 906 before the method 900 begins.

The method 900 begins at 918.1 with the HEW device 104 transmitting pilot 906.1 in the upper subcarrier range 214 and pilot 906.2 in the lower subcarrier range 216. The HEW device 104 may transmit pilot 906.1 at or near the end of the upper carrier range 214 and pilot 906.2 in the top portion of the lower subcarrier range 216. For example, the allocation bandwidth 212 may be 2.03125 MHz with 26 subcarriers. The HEW device 104 may transmit pilot 906.1 on subcarrier 26, 25, or 24, and pilot 906.2 on subcarrier 6, 7, or 8. Pilot 906.1 and pilot 906.2 may be transmitted with a gap between them.

The method 900 continues at 918.2 with the HEW device 104 transmitting pilot 906.3 in the lower subcarrier range 216 and pilot 906.4 in the upper subcarrier range 214. The HEW device 104 may transmit pilot 906.3 and at or near the end of the lower subcarrier range 216 and pilot 906.4 in the top portion of the upper subcarrier range 214. For example, the allocation bandwidth 212 may be 2.03125 MHz with 26 subcarriers. The HEW device 104 may transmit pilot 906.3 on subcarrier 3, 2, or 1, and pilot 906.4 on subcarrier 11, 12, or 13.

The method 900 may continue with the HEW device 104 repeating the transmitting of a pilot 906 in the upper subcarrier range 214 and in the lower subcarrier range 216 with alternating between the pilot 906 being at or near the end of the upper or lower subcarrier range 214, 216 and the top portion of the upper or lower subcarrier range 214, 216.

In some embodiments, the HEW device 104 is configured to not transmit pilots 906 during some time periods 918. For example, the HEW device 104 may skip one or more time periods 918 before transmitting the next pilots 906.3, 906.4, or pilots 906.1, 906.2. In some embodiments, the HEW device 104 may transmit one or more of the pilots 906 at a higher power than the HEW device 104 transmits data in some of the other subcarriers of the frequency allocation bandwidth 212.

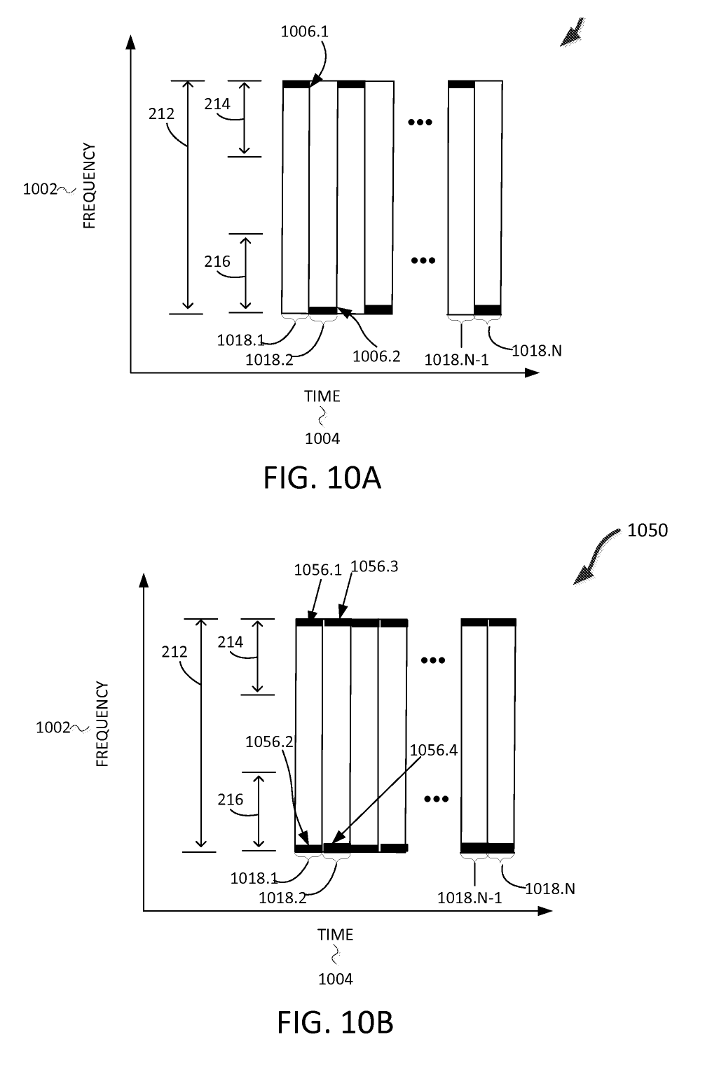

FIG. 10A illustrates a method 1000 of transmitting pilots 1006 in a WLAN, according to some disclosed embodiments. Illustrated in FIG. 10A is time 1004 along a horizontal axis and frequency 1002 along a vertical axis. Also illustrated are an allocation bandwidth 212, an upper subcarrier range 214, a lower subcarrier range 216, pilots 1006, and time periods 1018.1 through 1018.N. A HEW device 104 (FIG. 1) transmits pilots 1006 in a allocation bandwidth 212 during time periods 1018.1 through 1018.N. The HEW device 104 may receive an indication of a method to use to transmit pilots 1006 before the method 1000 begins.

The method 1000 begins at 1018.1 with the HEW device 104 transmitting pilot 1006.1 in the upper subcarrier range 214. The HEW device 104 may transmit pilot 1006.1 at or near the end of the upper carrier range 214. For example, the allocation bandwidth 212 may be 2.03125 MHz with 26 subcarriers. The HEW device 104 may transmit pilot 1006.1 on subcarrier 26, or 25, or 20.

The method 1000 continues at 1018.2 with the HEW device 104 transmitting pilot 1006.2 in the lower subcarrier range 216. The HEW device 104 may transmit pilot 1006.2 and at or near the end of the lower subcarrier range 216. For example, the allocation bandwidth 212 may be 2.03125 MHz with 26 subcarriers. The HEW device 104 may transmit pilot 1006.2 on subcarrier 1 or 2, or 7.

The method 1000 may continue with the HEW device 104 repeating the transmitting of a pilot 1006 in the upper subcarrier range 214 and, then in the next time period 1018, in the lower subcarrier range 216.

In some embodiments, the HEW device 104 is configured to not transmit a pilot 1006 during some time periods 1018. For example, the HEW device 104 may skip one or more time periods 1018 before transmitting the next pilot 1006.2, or pilots 1006.3, 1006.4. In some embodiments, the HEW device 104 may transmit one or more of the pilots 1006 at a higher power than the HEW device 104 transmits data in some of the other subcarriers of the frequency allocation bandwidth 212.

FIG. 10B illustrates a method 1050 of transmitting pilots 1056 in a WLAN, according to some disclosed embodiments. The method 1050 begins at 1018.1 with the HEW device 104 transmitting pilot 1056.1 in the upper subcarrier range 214 and pilot 1006.2 in the lower subcarrier range 216. The HEW device 104 may transmit pilot 1056.1 at or near the end of the upper carrier range 214. For example, the allocation bandwidth 212 may be 2.03125 MHz with 26 subcarriers. The HEW device 104 may transmit pilot 1056.1 on subcarrier 26, 25, or 20. The HEW device 104 may transmit pilot 1056.2 and at or near the end of the lower subcarrier range 216. For example, the allocation bandwidth 212 may be 2.03125 MHz with 26 subcarriers. The HEW device 104 may transmit pilot 1056.2 on subcarrier 1, 2, or 7.

The method 1050 may continue with the HEW device 104 repeating the transmitting of a pilot 1056 in the upper subcarrier range 214 and in the lower subcarrier range 216 for each time period 1018. In some example embodiments, the method 1050 may skip one or more time periods 1018. In some embodiments, the HEW device 104 may transmit one or more of the pilots 1056 at a higher power than the HEW device 104 transmits data in some of the other subcarriers of the frequency allocation bandwidth 212 as described herein.

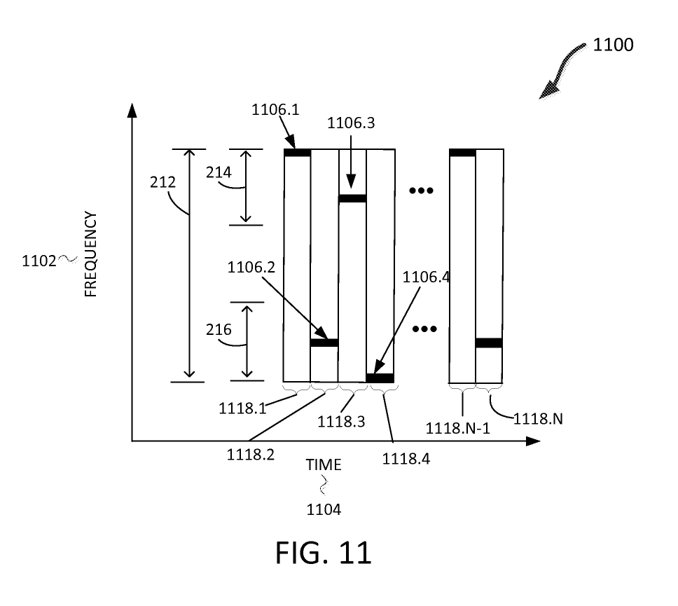

FIG. 11 illustrates a method 1100 of transmitting pilots 1106 in a WLAN, according to some disclosed embodiments. Illustrated in FIG. 11 is time 1104 along a horizontal axis and frequency 1102 along a vertical axis. Also illustrated are an allocation bandwidth 212, an upper subcarrier range 214, a lower subcarrier range 216, pilots 1106, and time periods 1118.1 through 1118.N. A HEW device 104 (FIG. 1) transmits pilots 1106 in an allocation bandwidth 212 during time periods 1118.1 through 1118.N. The HEW device 104 may receive an indication of a method 1100 to use to transmit pilots 1106 before the method 1100 begins.

The method 1100 begins at 1118.1 with the HEW device 104 transmitting pilot 1106.1 in the upper subcarrier range 214. The HEW device 104 may transmit pilot 1106.1 at or near the end of the upper carrier range 214. For example, the allocation bandwidth 212 may be 2.03125 MHz with 26 subcarriers. The HEW device 104 may transmit pilot 1106.1 on subcarrier 26, 25, or 24.

The method 1100 continues at 1118.2 with the HEW device 104 transmitting pilot 1106.2 in the lower subcarrier range 216. The HEW device 104 may transmit pilot 1106.2 and at or near the middle of the lower subcarrier range 216. For example, the allocation bandwidth 212 may be 2.03125 MHz with 26 subcarriers. The HEW device 104 may transmit pilot 1106.2 on subcarrier 5, 6, 7, or 8.

The method 1100 continues at 1118.3 with the HEW device 104 transmitting pilot 1106.3 in the bottom of the upper subcarrier range 214. The HEW device 104 may transmit pilot 1106.3 and at or near the bottom of the upper subcarrier range 214. For example, the allocation bandwidth 212 may be 2.03125 MHz with 26 subcarriers. The HEW device 104 may transmit pilot 1106.3 on subcarrier 21, 20, 19, or 18.

The method 1100 continues at 1018.4 with the HEW device 104 transmitting pilot 1106.4 in the lower subcarrier range 216. The HEW device 104 may transmit pilot 1106.4 and at or near the end of the lower subcarrier range 216. For example, the allocation bandwidth 212 may be 20 MHz with 16 subcarriers. The HEW device 104 may transmit pilot 1106.4 on subcarrier 1, 2, or 3.

The method 1100 may continue with the HEW device 104 repeating the transmitting of a pilot 1106 in the upper subcarrier range 214, then in the next time period 1118, in the top portion of the lower subcarrier range 216, then in the bottom of the upper subcarrier range 214, and then at the end of the lower subcarrier range 216. In some embodiments, the HEW device 104 may transmit one or more of the pilots 1106 at a higher power than the HEW device 104 transmits data in some of the other subcarriers of the frequency allocation bandwidth 212.

FIG. 1200 illustrates a method 1200 of transmitting pilots 1206 in a WLAN, according to some disclosed embodiments. Illustrated in FIG. 11 is time 1204 along a horizontal axis and frequency 1202 along a vertical axis. Also illustrated are an allocation bandwidth 212, an upper subcarrier range 214, a lower subcarrier range 216, pilots 1206, and time periods 1218.1 through 1218.N. A HEW device 104 (FIG. 1) transmits pilots 1206 in an allocation bandwidth 212 during time periods 1218.1 through 1218.N. The HEW device 104 may receive an indication of a method 1200 to use to transmit pilots 1206 before the method 1200 begins.

The method 1200 begins at 1218.1 with the HEW device 104 transmitting pilot 1206.1 in the upper subcarrier range 214. The HEW device 104 may transmit pilot 1206.1 within the upper carrier range 214. For example, the allocation bandwidth 212 may be 2.03125 MHz with 26 subcarriers. The HEW device 104 may transmit pilot 1206.1 on subcarrier 26, 25, 24, or 20.

The method 1200 continues at 1218.2 with the HEW device 104 not transmitting a pilot 1206 for one or more time periods 1218. The method 1200 continues at 1218.3 with the HEW device 104 transmitting pilot 1206.2 in the lower subcarrier range 216. The HEW device 104 may transmit pilot 1206.2 within the lower subcarrier range 216. For example, the allocation bandwidth 212 may be 2.03125 MHz with 26 subcarriers. The HEW device 104 may transmit pilot 1206.2 on subcarrier 1, 2, 3, or 7.

The method 1200 continues in this way with skipping one or more time periods 1218, transmitting a pilot 1206 in the upper subcarrier range 214, skipping one or more time periods 1218, and then transmitting a pilot 1206 in the lower subcarrier range 216. In some embodiments, the HEW device 104 may transmit one or more of the pilots 1206 at a higher power than the HEW device 104 transmits data in some of the other subcarriers of the frequency allocation bandwidth 212.

FIG. 13 illustrates a method 1300 of transmitting pilots in a WLAN, according to some disclosed embodiments. Illustrated in FIG. 13 is time 1304 along a horizontal axis and frequency 1302 along a vertical axis. Also illustrated are an allocation bandwidth 212, an upper subcarrier range 214, a lower subcarrier range 216, pilots 1306, and time periods 1318.1 through 1318.N. A HEW device 104 (FIG. 1) transmits pilots 1306 in an allocation bandwidth 212 during time periods 1318.1 through 1318.N. The HEW device 104 may receive an indication of a method 1300 to use to transmit pilots 1306 before the method 1300 begins.

The method 1300 begins at 1318.1 with the HEW device 104 transmitting pilot 1306.1 in the upper subcarrier range 214. The HEW device 104 may transmit pilot 1306.1 at or near the end of the upper carrier range 214. For example, the allocation bandwidth 212 may be 2.03125 MHz with 26 subcarriers. The HEW device 104 may transmit pilot 1306.1 on subcarrier 26, 25, 24, or 23.

The method 1300 continues at 1318.2 with the HEW device 104 not transmitting a pilot 1306 for one or more time periods 1318.

The method 1300 continues at 1318.3 with the HEW device 104 transmitting pilot 1306.2 in the lower subcarrier range 216. The HEW device 104 may transmit pilot 1306.2 and at or near the end of the lower subcarrier range 216. For example, the allocation bandwidth 212 may be 2.03125 MHz with 26 subcarriers. The HEW device 104 may transmit pilot 1306.2 on subcarrier 1, 2, 3, or 4. The method 1300 continues at 1318.4 with the HEW device 104 not transmitting a pilot 1306 for one or more time periods 1318.

The method 1300 continues at 1318.5 with the HEW device 104 transmitting pilot 1306.3 in the bottom of the upper subcarrier range 214. For example, the HEW device 104 may transmit the pilot 1306.3 on subcarrier 18, 19, 20, 21, or 22. The method 1300 continues at 1318.6 with the HEW device 104 not transmitting a pilot 1306 for one or more time periods 1318.

The method 1300 continues at 1318.7 with the HEW device 104 transmitting pilot 1306.4 in the top portion of the lower subcarrier range 216. For example, the HEW device 104 may transmit the pilot 1306.4 on subcarrier 5, 6, 7, 8, or 9.

The method 1300 continues in this way with skipping one or more time periods 1318, transmitting a pilot 1306 in the upper subcarrier range 214, skipping one or more time periods 1318, transmitting a pilot 1306 in the lower subcarrier range 216, skipping one or more time periods 1318, transmitting a pilot 1306 in the upper subcarrier range 214, skipping one or more time periods 1218, and then transmitting a pilot 1306 in the lower subcarrier range 216. In some embodiments, the HEW device 104 may transmit one or more of the pilots 1306 at a higher power than the HEW device 104 transmits data in some of the other subcarriers of the frequency allocation bandwidth 212.

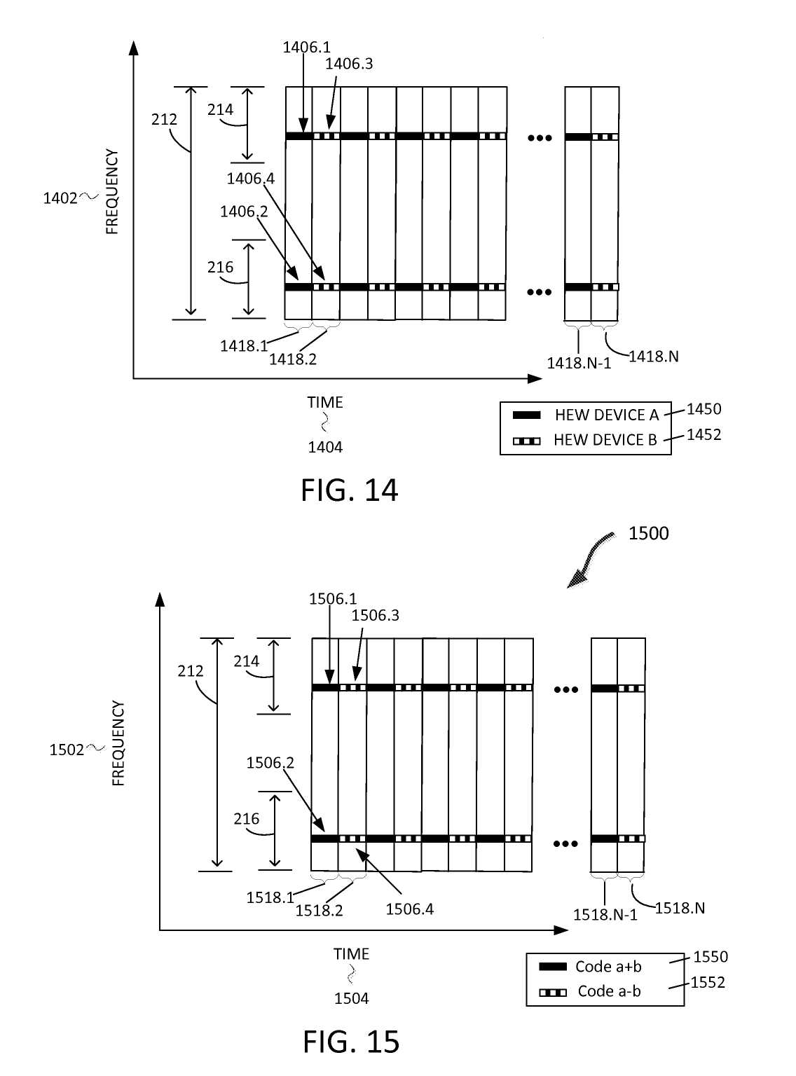

FIG. 14 illustrates a method 1400 of transmitting pilots 1406 in a WLAN, according to some disclosed embodiments. Illustrated in FIG. 14 is time 1404 along a horizontal axis and frequency 1402 along a vertical axis. Also illustrated are an allocation bandwidth 212, an upper subcarrier range 214, a lower subcarrier range 216, pilots 1406, and time periods 1418.1 through 1418.N. HEW device A 1450 and HEW device B 1452 are sharing the pilot subcarriers in a frequency allocation bandwidth 212 using TDMA and transmitting pilots 1406 during time periods 1418.1 through 1418.N.

HEW device A 1450 and HEW device B 1452 may share a frequency allocation bandwidth 212 using spatial multiplexing. For example, the data of HEW device A 1450 and HEW device B 1452 may be sent on the data subcarriers of frequency allocation bandwidth 212 simultaneously. HEW device A 1450 and HEW device B 1452 may receive an indication of a method 1400 to use to transmit pilots 1406 before the method 1400 begins. The pilot transmission schedules or locations for all HEW devices 1450, 1452 sharing the pilot subcarriers may be indicated by a scheduling HEW device 104 such as the access point 102 of the cell.

The method 1400 may begin at time period 1418.1 with HEW device A 1450 transmitting pilot 1406.1 in the upper subcarrier range 214 and pilot 1406.2 in the lower subcarrier range 216. The time periods 1418 may be symbols in OFDMA. The method 1400 may continue at 1418.2 with the HEW device B 1452 transmitting pilot 1406.3 in the upper subcarrier range 214 and pilot 1406.4 in the lower subcarrier range 216. The method 1400 may continue in this fashion where HEW device A 1450 and HEW device B 1552 transmit pilots 1406 during their time allocation of the frequency allocation bandwidth 212. The HEW device A 1450 and HEW device B 1452 may continue in this fashion where HEW device A 1450 transmits in odd time periods 1418, which may be OFDMA symbols, and where HEW device B 1452 transmits pilots 1406 in even time periods 1418, which may be OFDMA symbols.

In example embodiments, HEW device A 1450 and HEW device B 1452 may perform a method where HEW device A 1450 transmits a pilot 1406 (not illustrated) in the upper subcarrier range 214 and HEW device B 1452 transmits a pilot 1406 (not illustrated) in the lower subcarrier range 216. The method may continue with the HEW device B 1452 transmitting a pilot 1406 (not illustrated) in the upper subcarrier range 214 and HEW device A 1450 transmitting a pilot 1406 (not illustrated) in the lower subcarrier range 216. The method may continue in this alternating fashion and may not transmit a pilot 1406 in one or more symbols.

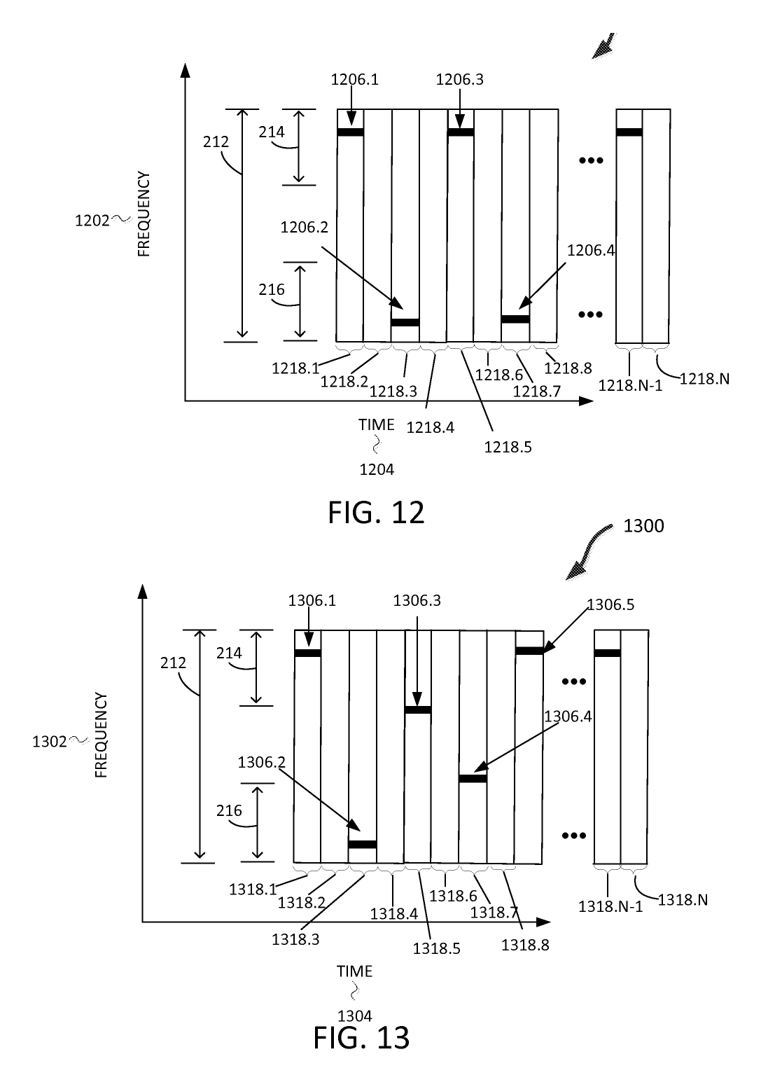

In some embodiments, the methods described in conjunction with FIGS. 2-13 may be used by HEW device A 1450 or HEW device B 1452 during their time allocation. For example, HEW device A 1450 may use the method described in conjunction with FIG. 9, and HEW device B 1452 may use the method described in conjunction with FIG. 11. In some embodiments, the HEW device A 1450 and/or HEW device B 1452 may transmit one or more of the pilots 1406 at a higher power than HEW device A 1450 or HEW device B 1452 transmits data in some of the other subcarriers of the frequency allocation bandwidth 212. In some embodiments, more than two HEW devices 104 may share the frequency allocation bandwidth 212.

FIG. 15 illustrates a method 1500 of transmitting pilots 1506 in a WLAN, according to some disclosed embodiments. Illustrated in FIG. 15 is time 1504 along a horizontal axis and frequency 1502 along a vertical axis. Also illustrated are an allocation bandwidth 212, an upper subcarrier range 214, a lower subcarrier range 216, pilots 1506, and time periods 1518.1 through 1518.N. HEW device A 1550 and HEW device B 1552 are sharing the pilot subcarriers of an frequency allocation bandwidth 212 using CDMA and transmitting pilots 1506 using their codes during time periods 1518.1 through 1518.N. In example embodiments, HEW device A 1550 and HEW device B 1552 may share the frequency allocation bandwidth 212 using spatial multiplexing. For example, HEW device A 1550 and HEW device B 1552 may transmit simultaneously using spatial diversity on data subcarriers of frequency allocation bandwidth 212. HEW device A 1550 and HEW device B 1552 may receive an indication of a method 1500 to use to transmit pilots 1506 before the method 1500 begins. The pilot transmission schedules or locations for HEW devices 104 sharing the pilot subcarriers may be indicated by a scheduling HEW device such as the AP 102 of the BSS 100.

The method 1500 may begin at time periods 1518.1 and 1518.2 with HEW device A 1550 transmitting pilot 1506.1 and pilot 1506.3 in the upper subcarrier range 214 and/or pilot 1506.2 and pilot 1506.4 in the lower subcarrier range 216, where the pilots 1506 are multiplied by a code sequence (a, b). For example, if pilot 1506.1 and pilot 1506.3 are ones then the transmitted pilot symbols of HEW device A 1550 are a and b, respectively.

Also at time periods 1518.1 and 1518.2, HEW device B 1552 transmits pilot 1506.1 and pilot 1506.3 in the upper subcarrier range 214 and/or pilot 1506.2 and pilot 1506.4 in the lower subcarrier range 216 using a code sequence orthogonal to (a, b) that is (conjugate(b),−conjugate(a)) or (−conjugate(b),conjugate(a)). For example, if pilot 1506.1 and pilot 1506.3 are ones, then the transmitted pilot symbols of HEW device B 1552 are b and −a, respectively. In example embodiments, a and b are ones resulting in (a,b)=(1,1) and (conjugate(a),−conjugate(b)), (1,−1).

In example embodiments, a and b can be one and zero, respectively, resulting in (a,b)=(1,0) and (a,b)=(0,1), which may be equivalent to the time sharing case in FIG. 14. Orthogonal code sequences with different lengths are disclosed in an identity matrix and a P matrix of 802.11n/ac and discrete Fourier transform (DFT) or fast Fourier transform (FFT) matrix and other orthogonal matrixes such as Hadamard matrix. In example embodiments, the identity matrix with (1,0) and (0,1) orthogonal codes may be time sharing. In example embodiments, the code sequences used in the upper subcarrier range 214 and the lower subcarrier range 216 are different. For example, HEW device A 1550 may use (a,b) and (conjugate(b),−conjugate(a)) in 214 and 216, respectively while HEW device B 1552 may use (conjugate(b),−conjugate(a)) and (a,b) in an upper subcarrier range 214, a lower subcarrier range 216, respectively.

The method 1500 may continue in this fashion where HEW device A 1550 and HEW device B 1552 transmit pilots 1506 using their codes in the frequency allocation bandwidth 212. In some embodiments, the methods described in conjunction with FIGS. 2-14 may be used by HEW device A 1550 or HEW device B 1552 during their code allocation. For example, HEW device A 1550 may use the method described in conjunction with FIG. 9, and HEW device B 1552 may use the method described in conjunction with FIG. 10. In some embodiments, the HEW device A 1550 and/or HEW device B 1552 may transmit one or more of the pilots 1506 at a higher power than HEW device A 1550 or HEW device B 1552 transmits data in some of the other subcarriers of the frequency allocation bandwidth 212.

In some embodiments, more than two HEW devices 104 may share the frequency allocation bandwidth 212 using CDMA. The code sequences for all HEW devices 104 sharing the pilot subcarriers may be indicated by a scheduling HEW device such as the AP 102 of the BSS 100. For example, an AP 102 may assign an orthogonal or P matrix code sequence to each HEW device 104 sharing the frequency allocation bandwidth 212 either by spatial diversity or CDMA. The rows or columns of the matrix contain orthogonal code sequences. Each code sequence can be assigned to a different user. In example embodiments, the code length is not equal to or greater than the number of HEW devices 104 sharing the pilot subcarrier.

In example embodiments, HEW device A 1550 and HEW device B 1552 may share the pilots 1506 using CDMA with both transmitting pilots 1506 at the same time. In example embodiments, the HEW device A 1550 and HEW device B 1552 may share the pilots subcarriers in both in time and frequency.

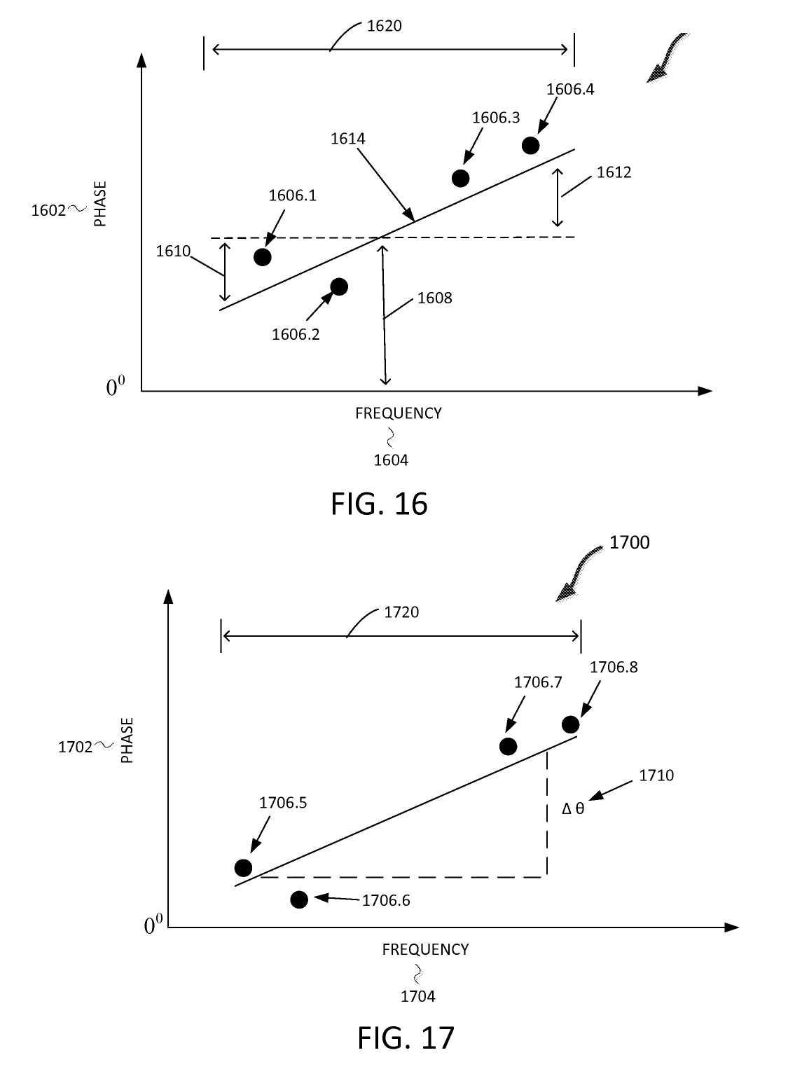

FIGS. 16 and 17 illustrate the effect of residual carrier frequency offset (CFO) and sampling clock offset (SCO) for pilot 1506 placements, according to example embodiments. Illustrated in FIGS. 16 and 17 are a phase 1602 along a vertical axis, a frequency 1604 along the horizontal axis, a frequency allocation 1620, and phases 1606. Additionally, illustrated in FIG. 16 are a slope 1614, tilts 1610, 1612, and the mean 1608 of the phases 1606. Moreover, illustrated in FIG. 17 is the phase change (AO) 1710, which is the change in the phase 1702.

The HEW device 104 and/or AP 102 may determine an initial CFO from the long training field (LTF) (not illustrated). The HEW device 104 may estimate the CFO and SCO using the phases 1606. The phases 1606 may be determined by the pilots (e.g., 206, 306, etc.) and may be corrupted by noise, and the HEW device 104 may have compensated or removed the modulation sequence and responses.

If the CFO is fully compensated, then the phase response on the pilot tone should remain unchanged over time such as from one OFDM symbol to another so that the mean 1608 of the phases 1606 would be zero. If there is a residual CFO that has not been compensated, then the phase response on the pilot, which is used to determine the phases 1606, linearly increases (or decreases) over time (as illustrated in FIGS. 16 and 17 with the slope, in this case, increasing). In addition, the phase change 1602 due to residual CFO is the same regardless of the pilot location in the frequency domain of the frequency allocation 1620.

The frequency allocation 1620 may be the bandwidth as described herein, e.g. 20 MHz. The SCO also introduces a phase 1602 change, which linearly increases (or decreases) with subcarrier frequency 1604, and causes the tilts 1610, 1612. Sine IEEE standards such as 802.11 recommend that the carrier frequency (not illustrated) and the sample clock (not illustrated) should be derived from the same oscillator, so the ratio between CFO and SCO is often more than 100. For example, the CFO is typically between 200 and 2,000 kHz, and SCO is typically between 2 and 200 Hz. Thus, the CFO is often the dominant factor of phase 1602 change.

The HEW device 104 and/or AP 102 determine the residual CFO from the mean 1608 of the four phases 1606 as time progresses. The HEW device 104 and/or AP 102 determine the SCO by the slope 1614 determined by the phases 1606 or the phase change (Δθ) 1710.

The placement of pilots closer to the edges of the frequency allocation 1620 may enable the HEW device 104 and/or AP 102 to determine the SCO more precisely by increasing the phase change (AO) 1710. The HEW device 104 and/or AP 102 may place the pilots (e.g. pilots 206, 306, 406, 506, 606, 706, 806, 906, 1006, 1106, 1206, 1306, 1406, 1506) toward the end of the frequency allocation 1620 as indicated by the derived phases 1606.1, 1606.4, 1706.5, and 1706.8. Moreover, the HEW device 104 and/or AP 102 may vary the placement of the pilots for frequency diversity to decrease the effect of subcarriers that are not received as well as other subcarriers. For example, 1606.1 and 1606.4 are not transmitted at the edge of the frequency allocation 1620, which may increase the frequency diversity.

Moreover, the HEW device 104 and/or AP 102 may transmit fewer pilots than legacy devices 106 or other standards by transmitting zero, one, or two pilots during a time period or OFDM symbol. For example, the HEW device 104 and/or AP 102 may only transmit two (not four as illustrated) pilots in FIGS. 16 and 17. As further examples, the methods 200, 300, 400, 500, 600, 700, 800, 900, 1000, 1100, 1200, 1300, 1400, 1500 may transmit zero, one, or two pilots during a TXOP. The HEW device 104 and/or AP 102 may transmit more than two pilots during other periods such as to communicate with legacy device 106, or during other communications.

The HEW device 104 and/or AP 102 may determine the CFO and SCO by using pilots transmitted at different times to determine the phases 1606. For example, phase 1606.1 may be determined from pilot 206.2 (FIG. 2), phase 1606.2 from pilot 206.4, phase 1606.3 from 206.1, and phase 1606.4 from 206.3.

In this way, the HEW device 104 and/or AP 102 may use more phases 1606 to determine the CFO and SCO than are transmitted during a time period, which may have the technical effect of increasing the accuracy of determining CFO and SCO without decreasing the efficiency of the transmissions due to extra pilots.

Thus, by transmitting fewer pilots the HEW device 104 and/or AP 102 may determine the CFO and SCO and have the technical effect of greater efficiency of the communications. For example, with a frequency allocation of 20 MHz and 4 pilots the overhead is 7% compared with an overhead of 3.5% for 2 pilots, or 1.75% for 1 pilot.

In the presence of noise and for a small bandwidth allocation, the determination of CFO and SCO may be better if the pilots are transmitted with a higher power. The HEW device 104 and/or AP 102 may transmit the pilots of FIGS. 2-17 using a higher power as described herein.

Moreover, by placing pilots at or near the edge of the frequency allocation, as is described in conjunction with FIGS. 2-21, the frequency diversity gain is increased for improved CFO determination, and the phase difference between the two pilots is increased for SCO determination.

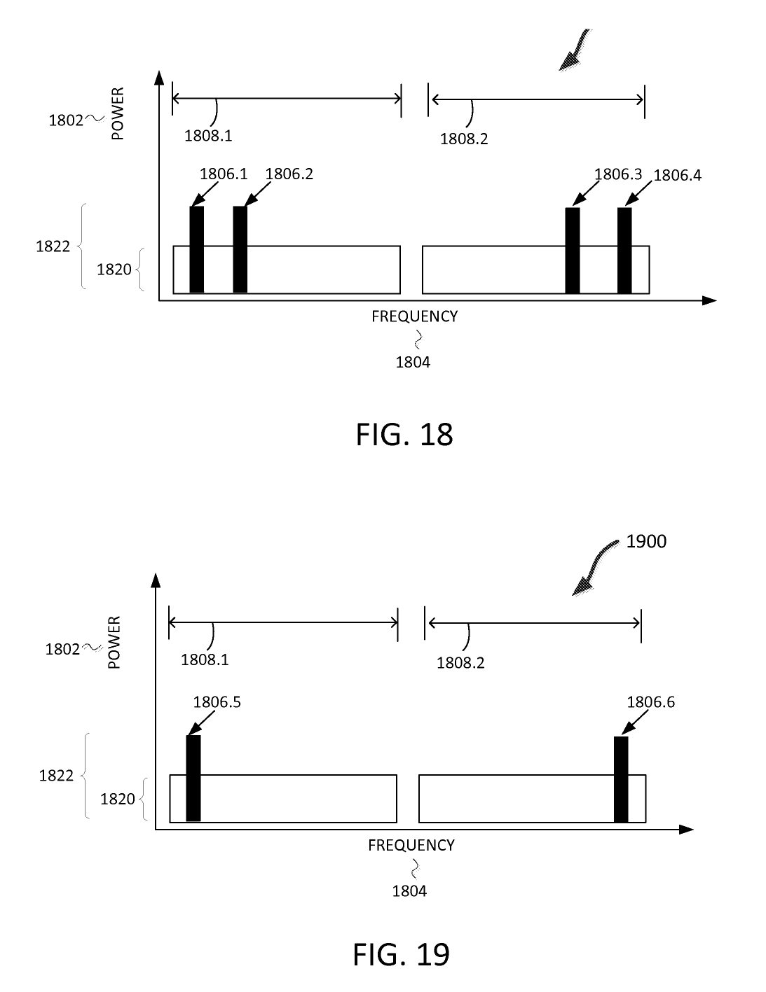

FIGS. 18, 19, and 20 illustrate pilot design for reduced pilots, according to some disclosed embodiments. Illustrated in FIGS. 18, 19, and 20 are power 1802 along a vertical axis, frequency along a horizontal axis 1804, pilots 1806, frequency allocations 1808, power 1822 used for pilots 1806, and power 1820 for other time periods.

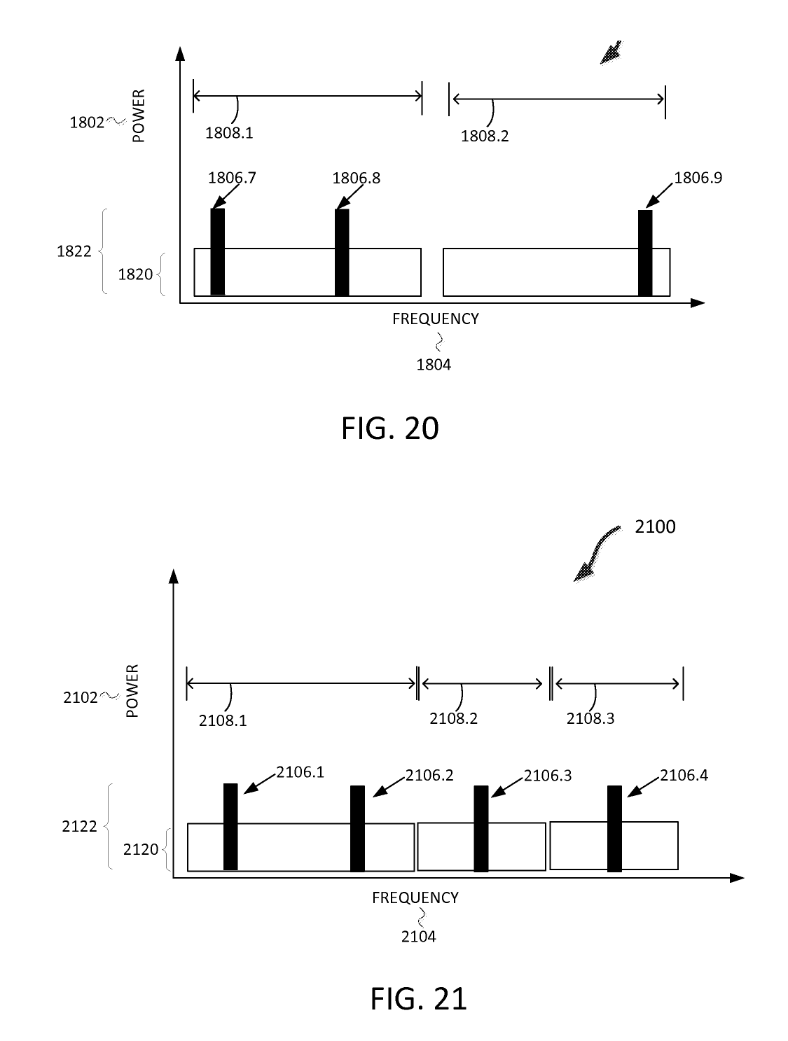

FIG. 18 illustrates a pilot 1806 design where two pilots 1806 are transmitted on either end of the frequency allocations 1808.1, 1808.2. FIG. 19 illustrates a pilot 1806 design where the pilots 1806.5, 1806.6 are near the edge of the frequency allocation 1808.1, 1808.2. FIG. 20 illustrates a pilot 1806 design where the pilots 1806.7 and 1806.9 are near the edge of the frequency allocation 1808, and pilot 1806.8 is near the middle of the upper portion of the frequency allocation 1808.1. The pilots 1806 may not be transmitted at the very edge of the frequency allocations 1808.1, 1808.2, since the transceiver 2302 (FIG. 23) response may roll off at the end of the frequency allocation 1808.1, 1808.2. The pilots 1806 may be transmitted on 2-9 subcarriers or within ⅛ of the operation bandwidth of frequency allocation 1808.1, 1808.2 (e.g. 1.25, 2.03125, 2.5, 5, 10, 20 or 80 MHz). The pilots 1806 may be transmitted at a power 1822 that is higher than the power 1820 for other portions of the transmissions.

The higher power 1822 may reduce the edge roll off of the transceiver 2302. The higher power 1822 may be a power that is up to two, three, or four times the power used for other transmissions 1820. The power 1822 for the pilots 1806 may be boosted in a range such as 10, 20, 30, 40, 50, 60, 70, 80, 90, or 100 percent more power than is currently used for pilots in legacy device 106. Other ranges may be used that are higher than the power used for legacy device 106.

In example embodiments, the higher power 1822 may be a power up to a power that is in accordance with one or more standards for how much power may be transmitted. For example, Federal Communication Commission (FCC) Part 15 Subpart E, EN 301 893 and EN 300 328; CEPT ECC DEC (04) 08, ETSI EN301 893; or, MIC Equipment Ordinance (EO) for Regulating Radio Equipment Articles 7, 49.20, 49.21a.

The higher power 1822 may compensate for the reduction in using few pilots 1806, which may compensate for a 0.2 dB loss due to pilot 1806 reduction. In some embodiments, the power of the pilots 1806 is boosted when the pilot 1806 is not at the end of the frequency allocation 1808, and is not boosted when the pilot 1806 is at the edge of the frequency allocation. This may be used for the methods and described in conjunction with FIGS. 2-21. Without power boosting, the packet error rate may degrade by a fraction of a dB, e.g. 0.1 to 0.2 dB.

Thus, by using fewer pilots 1806 with the pilot designs described in FIGS. 2-21, and boosting the power of at least some of the fewer pilots 1806 that are used, the communication may be more efficient without significantly increasing the packet error rate or decreasing the accuracy of the determination of CFO and SCO.

FIG. 21 illustrates pilot design for reduced pilots 2106, according to some disclosed embodiments. Illustrated in FIG. 21 are power 2102 along a vertical axis, frequency along a horizontal axis 2104, pilots 2106, frequency allocations 2108, power 2122 used for pilots 2106, and power 2120 for other time periods.

A first HEW device 104 may be allocated frequency allocation 2108.1, a second HEW device 104 may be allocated frequency allocation 2108.2, and a third HEW device 104 may be allocated frequency allocation 2108.3. The position of the pilots 2106 may be the same as used in legacy devices 106. The second and third HEW devices 104 may share the pilots 2106.3 and 2106.4 in the uplink transmission to the AP 102. In FDMA and/or CDMA the HEW devices 104 may share all of the pilots 2106. For example, in FIGS. 14 and 15 the HEW devices 104 alternate using the pilot 2106 locations using FDMA and CDMA. The different pilot 2106 designs as described in conjunction with FIGS. 2-21 may be used in conjunction with sharing the pilots.

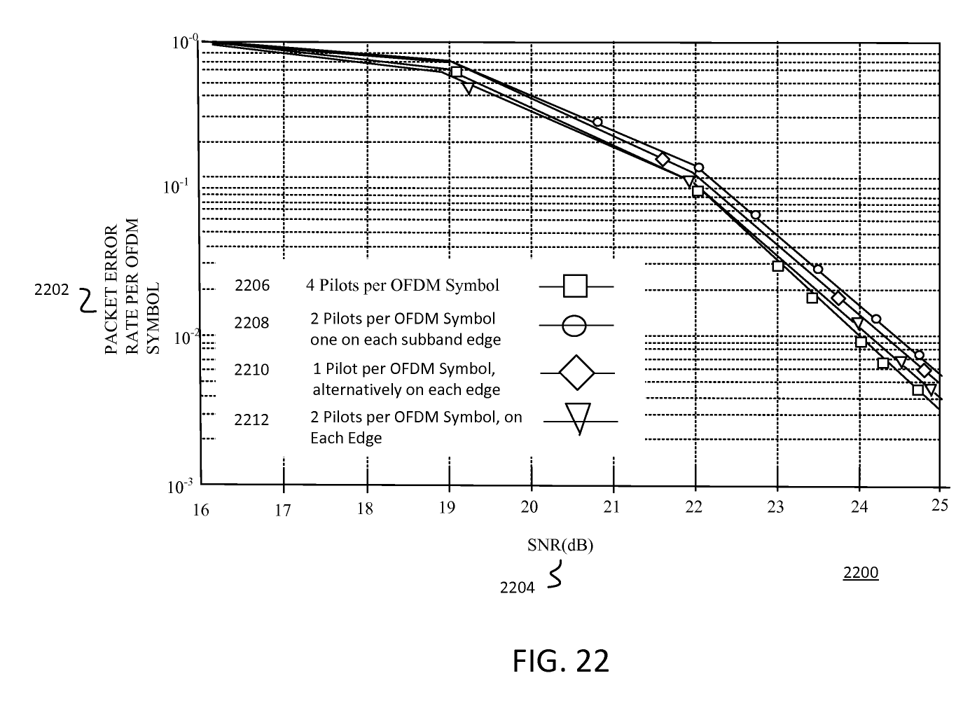

FIG. 22 illustrates the packet error rates from a simulation with different number and placement of pilots. An AP 102 was used with eight receive antennas, and four HEW devices 104, with each having one transmit antenna. The AP 102 and HEW devices 104 are configured with MU-MIMO, convolutional codes, and 64 QAM were used.

Illustrated in FIG. 22 are packet error rates per OFDM symbol 2202 along the vertical axis and signal to noise ratio (SNR) in decibel (dB) 2204 along the horizontal axis. The 4-pilot 2206 per OFDM symbol is the design used in legacy 802.11 systems. The 2 pilots per OFDM symbol one on each subcarrier (or frequency allocation) edge 2208 may be the method 800 illustrated in FIG. 8. The 1 pilot per OFDM symbol alternatively on each edge 2210 may be the method 1000 illustrated in FIG. 10A. The 2 pilots per OFDM symbol on each edge 2212 may be the method 1050 illustrated in FIG. 10B. Thus, the simulation results indicate that the legacy 4-pilot design 2206 is less efficient and may be replaced with one of the other designs 2208, 2210, or 2212 without a significant increase in the packet error rate per OFDM symbol 2202.

For uplink MU-MIMO multiple HEW devices 104 may share the same frequency-time resource allocation with different spatial allocations. In some embodiments, HEW devices 104 that share the same frequency time allocation also use the same bandwidth or frequency allocation. For example, if one HEW device 104 uses 10 MHz, then the other HEW devices 104 would use 10 MHz too.

In some embodiments, the HEW devices 104 are configured to not collide with one another in the frequency domain. For example, each HEW device 104 that shares a frequency-time domain for a spatial allocation uses different positions to transmit the pilot subcarrier.

In some embodiments, the HEW devices 104 that share frequency-time domains with different spatial allocations are configured to transmit the pilots at the same time and frequency during a TXOP. For example, the AP 102 may schedule three HEW devices 104, STA 1, STA 2, and STA 3, in the uplink MU-MIMO allocation. STA 1 has 2 spatial streams. STA 2 and STA 3 each have one spatial stream. The two streams of STA 1 can just share the same set of pilot locations (e.g., FIGS. 2-21) because the CFO and SCO of all the spatial streams of the same STA are the same.

For the AP 102 to track the SCO of each STA, the AP 102 can rely on spatial multiplexing to separate the transmissions of the three STAs. After spatial multiplexing, the AP 102 reads the pilots of each STA and tracks their SCOs. There is a residual multi-STA interference in each STA's signal after the spatial multiplexing because of the imperfect channel estimation.

In some embodiments, the AP 102 is configured to assign orthogonal sequences to the STAs. For example, STA 1 may use [1, 1, 1, 1], STA 2 may use [1,1,−1,−1], and STA 3 may use [1, −1, 1, −1]. In this way, the AP 102 can suppress the multi-STA interference by dispreading or matched filtering of the received signals across OFDM symbols on that pilot subcarrier. In some embodiments, the pilot sequences that are defined in 802.11 and 802.11ac may be re-used for uplink MU-MIMO. In some embodiments, each STA uses a different sequence and each STA's multiple spatial streams share the same sequence. For example, if STA 1 has two antennae 2301 to send two spatial data streams, then it may send just a single spatial stream for the pilots. In some example embodiments, the STA can perform beam forming with the single spatial stream of pilots using the multiple antennas for increasing the signal to noise interference ratio. This may reduce the number of sequences, and thus the period of the sequences such that the interferences mitigation is enhanced.

The AP 102 or other HEW device 104 may indicate the pilot sequence or pilot pattern in a frame that schedules the uplink MU-MIMO transmission or TXOP. In example embodiments, if the transmitted sequences are not orthogonal among the STAs, then each STA needs to know the other STA's sequences. This may require the AP 102 or other HEW device 104 to indicate the sequences implicitly or explicitly to the STAs. For example, the AP 102 and STAs may be configured for the STA 1 to use sequence 1, STA 2 to use sequence 2, etc. In this way, the STAs and AP 102 know the sequences used by the each STA. In example embodiments, if the STAs and AP 102 are configured to use orthogonal sequences, each STA may need to know only their own sequence.

In some embodiments of FIGS. 2-21 the AP 102 or another HEW device 104 may transmit a pilot sequence or pilot pattern to the HEW device 102 or STA. The pilot sequence or pilot pattern may be included in a management frame or another frame.

In some embodiments, a cell-specific scrambling sequence is put on the top of the pilot sequence (e.g. XOR operation on the scrambling sequence and the orthogonal pilot sequence). By applying different scrambling sequences on each STA, the inter-cell interference is randomized such that a cell may not consistently be jammed by other cells. So, in example embodiments, the STAs and/or the AP 102 determine the final transmitted sequence on the pilot by the cell scrambling sequence and the orthogonal pilot sequence.

FIG. 23 illustrates a HEW device 2300 in accordance with example embodiments. HEW device 2300 may be an HEW compliant device that may be arranged to communicate with one or more other HEW devices 2300, such as HEW devices 104 (FIG. 1) or access point 102 (FIG. 1) as well as communicate with legacy devices 106 (FIG. 1). HEW devices 104 and legacy devices 106 may also be referred to as HEW stations (STAs) and legacy STAs, respectively. HEW device 2300 may be suitable for operating as access point 102 (FIG. 1) or an HEW device 104 (FIG. 1). In accordance with embodiments, HEW device 2300 may include, among other things, a transmit/receive element 2301 (for example an antenna), a transceiver 2302, physical layer (PHY) circuitry 2304 and medium-access control layer circuitry (MAC) 2306. PHY 2304 and MAC 2306 may be HEW compliant layers and may also be compliant with one or more legacy IEEE 802.11 standards. MAC 2306 may be arranged to configure physical layer convergence procedure (PLCP) protocol data unit (PPDUs) and arranged to transmit and receive PPDUs, among other things.

HEW device 2300 may also include other hardware circuitry 2308 and memory 2310 may be configured to perform the various operations described herein. The hardware circuitry 2308 may be coupled to the transceiver 2302, which may be coupled to the transmit/receive element 2301. While FIG. 23 depicts the hardware circuitry 2308 and the transceiver 2302 as separate components, the hardware circuitry 2308 and the transceiver 2302 may be integrated together in an electronic package or chip.

In example embodiments, the HEW device 2300 is configured to perform one or more of the functions and/or methods described herein such as the methods, apparatuses, and functions described in conjunction with FIGS. 2 through 21, such as performing methods for transmitting pilot carriers and interpreting pilot carriers received and generating and interpreting indications of which method of transmitting pilot carriers to use.

The PHY 2304 may be arranged to transmit the HEW PPDU. The PHY 2304 may include circuitry for modulation/demodulation, upconversion/downconversion, filtering, amplification, etc. In some embodiments, the hardware circuitry 2308 may include one or more processors. The hardware circuitry 2308 may be configured to perform functions based on instructions being stored in a RAM or ROM, or based on special purpose circuitry. In some embodiments, the hardware circuitry 2308 may be configured to perform one or more of the functions described herein for sending and receiving BARs and BAs.

In some embodiments, two or more antennas may be coupled to the PHY 2304 and arranged for sending and receiving signals including transmission of the HEW packets. The HEW device 2300 may include a transceiver 2302 to transmit and receive data such as HEW PPDU and packets that include an indication that the HEW device 2300 should adapt the channel contention settings according to settings included in the packet. The memory 2310 may store information for configuring the other circuitry to perform operations for one or more of the functions and/or methods described herein for methods of transmitting pilot carriers, interpreting received pilot carriers, and generating and interpreting indications of which methods of transmitting pilot carriers to use.

In some embodiments, the HEW device 2300 may be configured to communicate using OFDM communication signals over a multicarrier communication channel. In some embodiments, HEW device 2300 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, standards and/or proposed specifications for WLANs, although the scope of the example embodiments is not limited in this respect as they may also be suitable to transmit and/or receive communications in accordance with other techniques and standards. In some embodiments, the HEW device 2300 may use 4× symbol duration of 802.11n or 802.11ac.

In some embodiments, a HEW device 2300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point 102, a television, a medical device (e.g., a heart rate monitor, a blood pressure monitor, etc.), an access point 102, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 2301 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 2300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is a wireless communication station (STA) which may include circuitry. The circuitry may be configured to: receive one or more packets indicating a pilot pattern for the wireless communications STA to use; transmit a first pilot carrier in a lower subcarrier of a frequency allocation according the pilot pattern; and transmit a second pilot carrier in a higher subcarrier of the frequency allocation according to the pilot pattern. In example embodiments, the one or more packets may be received from a station or access point.

In Example 2, the subject matter of Example 1 can optionally include where the one or more packets further indicate a schedule for the wireless communications device to transmit in a transmit opportunity (TXOP), and wherein the circuitry is configured to transmit in the TXOP.

In Example 3, the subject matter of Example 2 can optionally include where the circuitry is further configured to transmit and receive in accordance with Orthogonal Frequency Division Multiple Access (OFDMA), and where the TXOP is obtained by from an access point.

In Example 4, the subject matter of any of Examples 1-3 can optionally include where the circuitry is configured to transmit the first pilot carrier and the second pilot carrier simultaneously.

In Example 5, the subject matter of any of Examples 1-4 can optionally include where the circuitry is configured to transmit respective pilot carriers within the frequency allocation, the frequency allocation comprising a plurality of basic frequency units each including pilot locations, the respective pilot carriers being at respective ones of the pilot locations.

In Example 6, the subject matter of Example 5 can optionally include where one of the plurality of basic frequency units is around muted subcarriers, and where the pilot locations of the one of the plurality of basic frequency units around muted subcarriers are such that so that the distance between the pilot locations are a same distance as between pilot locations of other basic frequency units of the plurality of basic frequency units that are not around muted subcarriers.

In Example 7, the subject matter of Example 5, the circuitry further being configured to transmit the first pilot carrier in a pilot location of a lower basic frequency unit of the plurality of basic frequency units and to transmit the second pilot carrier in a pilot location of an upper basic frequency unit of the plurality of basic frequency units.

In Example 8, the subject matter of Example 5 can optionally include where the basic frequency units are one from the following group: 1.25 MHz, 2.03125 MHz, 2.5 MHz, 5 MHz, and 10 MHz.

In Example 9, the subject matter of any of Examples 1-8 can optionally include where the lower subcarrier is in the lower one-third of the frequency allocation, and the higher subcarrier is in the higher one-third of the frequency allocation, and wherein the frequency allocation is one from the following group: 1.25 MHz, 2.03125 MHz, 2.5 MHz, 5 MHz, 10 MHz, 20 MHz, 40 MHz, 80 MHz, and 160 MHz.

In Example 10, the subject matter of any of Examples 1-9 can optionally include where the lower subcarrier is a last subcarrier or a second to the last subcarrier of the lower subcarrier, and the higher subcarrier is a last subcarrier or a second to the last subcarrier of the higher subcarrier.

In Example 11, the subject matter of any of Examples 1-10 can optionally include where the circuitry is further configured to: transmit a third pilot carrier in the lower subcarrier of the frequency allocation simultaneously with the first pilot carrier; and transmit a fourth pilot carrier in the higher subcarrier of the frequency allocation simultaneously with the second pilot carrier.

In Example 12, the subject matter of Examples 11 can optionally include where the circuitry is further configured to: transmit the first pilot carrier and the third pilot carrier in alternative time periods from the second pilot carrier and fourth pilot carrier.

In Example 13, the subject matter of any of Examples 1-12 can optionally include where the circuitry is further configured to: receive a fifth pilot from an access point (AP) within the frequency allocation; receive a sixth pilot from the AP outside of the frequency allocation; and use the fifth pilot and the sixth pilot to determine a clock of the AP.

In Example 14, the subject matter of any of Examples 1-13 can optionally include the circuitry being configured to transmit the first pilot carrier and the second pilot carrier with a higher power than data simultaneously transmitted on a different subcarrier than the lower subcarrier and the higher subcarrier, where the higher power is one from the following group: approximately 10 percent higher power, approximately 20 percent higher power, approximately 30 percent higher power, approximately 40 percent higher power, approximately 50 percent higher power, approximately 60 percent higher power, approximately 70 percent higher power, approximately 80 percent higher power, approximately 90 percent higher power, and approximately 100 percent higher power.

In Example 15, the subject matter of any of Examples 1-14 can optionally include where the frequency allocation comprises a plurality of smallest frequency allocations, and wherein each of the plurality of smallest frequency allocations includes pilot locations, and wherein the circuitry is further configured to: transmit the first pilot carrier in a lowest or second lowest pilot location of a lowest smallest frequency allocation of the plurality of frequency allocations; and transmit the second pilot carrier in a highest or second highest pilot location of a highest smallest frequency allocation of the plurality of frequency allocations.

In Example 16, the subject matter of any of Examples 1-15 can optionally include where the circuitry is further configured to: transmit in accordance with at least one of the following group: code division multiple access (CDMA) and time division multiple access (TDMA), and configured to alternate time periods with another wireless communication device to transmit the first pilot carrier and the second pilot carrier.

In Example 17, the subject matter of Example 1 can optionally include where the circuitry is further configured to: transmit a third pilot carrier in a second spatial stream in the lower subcarrier of the frequency allocation; and transmit a fourth pilot carrier in a second spatial stream in the upper subcarrier of the frequency allocation, where the first pilot carrier and the second pilot carrier are transmitted in a first spatial stream, and the third pilot carrier and the fourth pilot carrier are transmitted at a same frequency location as the first pilot carrier and the second pilot carrier, respectively, and where the wireless communication device is configured to transmit in accordance with multi-user multiple-input multiple-output (MU-MIMO).

In Example 18, the subject matter of Examples 17 can optionally include where the circuitry is further configured to: receive an indication of a sequence orthogonal to another sequence to be used by another wireless communication device; and transmit the first pilot carrier, second pilot carrier, third pilot carrier, and fourth pilot carrier based on the sequence.

In Example 19, the subject matter of any of Examples 1-18 can optionally include memory coupled to the circuitry.

In Example 20, the subject matter of Example 19 can optionally include one or more antennas coupled to the circuitry.

Example 21 is a method on a wireless communications station (STA). The method may include receiving one or more packets in a transmit opportunity (TXOP), wherein the one or more packets indicate a schedule for the wireless communication device to transmit; transmitting a first pilot carrier in a lower subcarrier of a frequency allocation; and transmitting a second pilot carrier in a higher subcarrier of the frequency allocation. In example embodiments, the one or more packets may be received from a station or access point.

In Example 22, the subject matter of Examples 21 can optionally include where the first pilot carrier and the second pilot carrier are transmitted simultaneously.

In Example 23, the subject matter of Examples 21 or 22 can optionally include where the transmitting and receiving further includes transmitting and receiving in accordance with Orthogonal Frequency Division Multiple Access (OFDMA) and Institute for Electrical and Electronic Engineers (IEEE) 802.11ax.

In Example 24, the subject matter of any of Examples 21-23 can optionally include where the transmitting the second pilot carrier further includes transmitting the second pilot carrier in alternative time periods from the first pilot carrier.

Example 25 is a wireless communication device. The device may include circuitry configured to: transmit one or more packets to initiate a transmit opportunity (TXOP) to a plurality of wireless communication devices, wherein the one or more packets indicate a schedule for the two or more wireless communication devices to transmit; receive a first pilot carrier in a lower subcarrier of a first frequency allocation from a first wireless communication device of the plurality of wireless communication devices; and receive a second pilot carrier in a higher subcarrier of the frequency allocation from the first wireless communication device.

In Example 26, the subject matter of Example 25 can optionally include a memory coupled to the circuitry; and one or more antennas coupled to the circuitry.

In Example 27, the subject matter of Examples 25 or 26 can optionally include where the circuitry is further configured to: determine a residual carrier frequency (CFO) a sampling clock offset (SCO) for the first wireless communication device using the first pilot carrier and the second pilot carrier.

In Example 28, the subject matter of any of Examples 25-27 can optionally include where the first pilot carrier and the second pilot carrier are received in alternative time periods.

Example 29 is a non-transitory computer-readable storage medium that stores instructions for execution by one or more processors to perform operations to transmit pilot carriers performed by a wireless communication device. The instructions configure the one or more processors to cause the wireless communication device to: receive one or more packets in a transmit opportunity (TXOP) from an access point (AP), wherein the one or more packets indicate a schedule for the wireless communication device to transmit; transmit a first pilot carrier in a lower subcarrier of a frequency allocation; and transmit a second pilot carrier in a higher subcarrier of the frequency allocation.

In Example 30, the subject matter of Example 29 can optionally include where the lower subcarrier is in the lower one-third of the frequency allocation, and the higher subcarrier is in the higher one-third of the frequency allocation, and wherein the frequency allocation is one from the following group: 1.25 MHz, 2.03125 MHz, 2.5 MHz, 5 MHz, 10 MHz, 20 MHz, 40 MHz, 80 MHz, and 160 MHz. The subject matter of Examples 21-30 may include receive one or more packets indicating a pilot pattern for the wireless communications STA to use, wherein the one or more packets are received from an access point or second STA.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A wireless communication station (STA), the STA comprising circuitry configured to:
receive one or more packets, indicating a pilot pattern for the wireless communications STA to use;
transmit a first pilot carrier in a lower subcarrier of a frequency allocation according to the pilot pattern; and
transmit a second pilot carrier in a higher subcarrier of the frequency allocation according to the pilot pattern.

2. The wireless communication STA of claim 1, wherein the one or more packets further indicate a schedule for the wireless communications device to transmit in a transmit opportunity (TXOP), and wherein the circuitry is configured to transmit in the TXOP.

3. The wireless communication STA of claim 2, wherein the circuitry is further configured to transmit and receive in accordance with Orthogonal Frequency Division Multiple Access (OFDMA).

4. The wireless communication STA of any of claim 1, wherein the circuitry is configured to transmit the first pilot carrier and the second pilot carrier simultaneously.

5. The wireless communication STA of claim 4, wherein the circuitry is configured to transmit respective pilot carriers within the frequency allocation, the frequency allocation comprising a plurality of basic frequency units each including pilot locations, the respective pilot carriers being at respective ones of the pilot locations.

6. The wireless communication STA of claim 5, wherein one of the plurality of basic frequency units is around muted subcarriers, and wherein the pilot locations of the one of the plurality of basic frequency units around muted subcarriers are such that that the distance between the pilot locations are a same distance as between pilot locations of other basic frequency units of the plurality of basic frequency units that are not around muted subcarriers.

7. The wireless communication STA of claim 5, the circuitry further being configured to transmit the first pilot carrier in a pilot location of a lower basic frequency unit of the plurality of basic frequency units and to transmit the second pilot carrier in a pilot location of an upper basic frequency unit of the plurality of basic frequency units.

8. The wireless communication STA of claim 5, wherein the basic frequency units are one from the following group: 1.25 MHz, 2.03125 MHz, 2.5 MHz, 5 MHz, and 10 MHz.

9. The wireless communication STA of claim 1, wherein the lower subcarrier is in the lower one-third of the frequency allocation, and the higher subcarrier is in the higher one-third of the frequency allocation, and wherein the frequency allocation is one from the following group: 1.25 MHz, 2.03125 MHz, 2.5 MHz, 5 MHz, 10 MHz, 20 MHz, 40 MHz, 80 MHz, and 160 MHz.

10. The wireless communication STA of claim 1, wherein the lower subcarrier is a last subcarrier or a second to the last subcarrier of the lower subcarrier, and the higher subcarrier is a last subcarrier or a second to the last subcarrier of the higher subcarrier.

11. The wireless communication STA of claim 1, wherein the circuitry is further configured to:
transmit a third pilot carrier in the lower subcarrier of the frequency allocation simultaneously with the first pilot carrier; and
transmit a fourth pilot carrier in the higher subcarrier of the frequency allocation simultaneously with the second pilot carrier.

12. The wireless communication STA of claim 11, wherein the circuitry is further configured to:
transmit the first pilot carrier and the third pilot carrier in alternative time periods from the second pilot carrier and fourth pilot carrier.

13. The wireless communication STA of claim 1, wherein the circuitry is further configured to:
receive a fifth pilot from an access point (AP) within the frequency allocation;
receive a sixth pilot from the AP outside of the frequency allocation; and
use the fifth pilot and the sixth pilot to determine a clock of the AP.

14. The wireless communication STA of claim 1, the circuitry being configured to transmit the first pilot carrier and the second pilot carrier with a higher power than data simultaneously transmitted by the STA on a different subcarrier than the lower subcarrier and the higher subcarrier, wherein the higher power is one from the following group: approximately 10 percent higher power, approximately 20 percent higher power, approximately 30 percent higher power, approximately 40 percent higher power, approximately 50 percent higher power, approximately 60 percent higher power, approximately 70 percent higher power, approximately 80 percent higher power, approximately 90 percent higher power, and approximately 100 percent higher power.

15. The wireless communication STA of claim 1, wherein the frequency allocation comprises a plurality of smallest frequency allocations, and wherein each of the plurality of smallest frequency allocations includes pilot locations, and wherein the circuitry is further configured to:
transmit the first pilot carrier in a lowest or second lowest pilot location of a lowest smallest frequency allocation of the plurality of frequency allocations; and
transmit the second pilot carrier in a highest or second highest pilot location of a highest smallest frequency allocation of the plurality of frequency allocations.

16. The wireless communication STA of claim 1, wherein the circuitry is further configured to:
transmit in accordance with at least one of the following group: code division multiple access (CDMA) and time division multiple access (TDMA), and configured to alternate time periods with another wireless communication device to transmit the first pilot carrier and the second pilot carrier.

17. The wireless communication STA of claim 1, wherein the circuitry is further configured to:
transmit a third pilot carrier in a second spatial stream in the lower subcarrier of the frequency allocation; and
transmit a fourth pilot carrier in a second spatial stream in the upper subcarrier of the frequency allocation, wherein the first pilot carrier and the second pilot carrier are transmitted in a first spatial stream, and the third pilot carrier and the fourth pilot carrier are transmitted at a same frequency location as the first pilot carrier and the second pilot carrier, respectively, and wherein the wireless communication device is configured to transmit in accordance with multi-user multiple-input multiple-output (MU-MIMO).

18. The wireless communications STA of claim 17, wherein the circuitry is further configured to:
receive an indication of a sequence orthogonal to another sequence to be used by another wireless communication device; and
transmit the first pilot carrier, second pilot carrier, third pilot carrier, and fourth pilot carrier based on the sequenced.

19. The wireless communications STA of claim 1, further comprising memory coupled to the circuitry.

20. The wireless communications STA of claim 19, further comprising one or more antennas coupled to the circuitry.

21. A method on a wireless communications station (STA), the method comprising:
receiving one or more packets in a transmit opportunity (TXOP) indicating a schedule for the wireless communication device to transmit;
transmitting a first pilot carrier in a lower subcarrier of a frequency allocation; and
transmitting a second pilot carrier in a higher subcarrier of the frequency allocation.

22. The method of claim 21, wherein the first pilot carrier and the second pilot carrier are transmitted simultaneously.

23. The method of claim 21, wherein the transmitting and receiving further comprises:
transmitting and receiving in accordance with Orthogonal Frequency Division Multiple Access (OFDMA).

24. A non-transitory computer-readable storage medium that stores instructions for execution by one or more processors to perform operations to transmit pilot carriers performed by a wireless communication device, the instructions to configure the one or more processors to cause the wireless communication device to:
receive one or more packets in a transmit opportunity (TXOP) indicating a schedule for the wireless communication device to transmit;
transmit a first pilot carrier in a lower subcarrier of a frequency allocation; and
transmit a second pilot carrier in a higher subcarrier of the frequency allocation.

25. The non-transitory computer-readable storage medium of claim 24, wherein the lower subcarrier is in the lower one-third of the frequency allocation, and the higher subcarrier is in the higher one-third of the frequency allocation, and wherein the frequency allocation is one from the following group: 1.25 MHz, 2.03125 MHz, 2.5 MHz, 5 MHz, 10 MHz, 20 MHz, 40 MHz, 80 MHz, and 16.
